(19) United States
(12) Patent Application Publication
(10) Pub. No.: US 2025/0072477 A1
(43) Pub. Date: Mar. 6, 2025

(54) HANDLING AND TREATMENT SYSTEM FOR PREROLLED CIGARETTES

(71) Applicant: Sorting Robotics, Inc., Los Angeles, CA (US)

(72) Inventors: Nohtal Partansky, Sherman Oaks, CA (US); Ryan McCanna, Valencia, CA (US); Louis Edelman, Williamsburg, VA (US); Benjamin Strauss, Hawthorn, CA (US); Alex Branchi, Los Angeles, CA (US); Ryan Pobanz, Chino Hills, CA (US)

(21) Appl. No.: 18/798,801

(22) Filed: Aug. 8, 2024

Related U.S. Application Data
(60) Provisional application No. 63/536,622, filed on Sep. 5, 2023.

(51) Int. Cl. A24C 5/60; B25J 15/00

(52) U.S. Cl. CPC A24C 5/608; B25J 15/0038

(57) ABSTRACT

A system configured to process prerolled cigarettes can include one or more prerolled cigarette holders, an adhesive spraying station, and a fluidized bed coating station. The adhesive spraying station can apply adhesive to prerolled cigarette(s) held by the prerolled cigarette holder(s) and inserted therein. The fluidized bed coating station can apply a coating to prerolled cigarette(s) held by the prerolled cigarette holder(s) after the prerolled cigarette(s) have had adhesive applied thereto. The system can form cannabis based infused prerolled cigarettes. The prerolled cigarette holders can be magnetic collet devices. Additional system components can include a prerolled cigarette holder loading station, a robotic arm, and an end effector.

### CROSS-REFERENCE TO RELATED APPLICATIONS

This application claims priority to U.S. Provisional Patent Application No. 63/536,622, filed Sep. 5, 2023, and titled “SYSTEMS, METHODS AND DEVICES FOR HANDLING AND TREATMENT OF PREROLLED CIGARETTES,” which application is hereby incorporated by reference in its entirety herein. This application is also related to U.S. patent application Ser. No. ______ filed on this same date of Aug. 8, 2024, and titled “ADHESIVE SPRAYING SYSTEM FOR PREROLLED CIGARETTES,” and also U.S. patent application Ser. No. ______ also filed on this same date of Aug. 8, 2024, and titled “MAGNETIC COLLET DEVICE,” which applications are also hereby incorporated by reference in their entireties herein.

### TECHNICAL FIELD

The present disclosure relates generally to cigarette manufacturing, and more particularly to systems and methods used in the production of prerolled cigarettes.

### BACKGROUND

The tobacco, hemp, and cannabis industries have evolved significantly with the diversification of products aimed at delivering cannabinoids to users. A prominent product in this space is the “preroll,” encompassing various forms like joints, blunts, dogwalkers, and the like. With recent waves of legalization there have been surges in popularity for “infused prerolls,” which are prerolls that are coated with an adhesive or cannabinoid concentrate and then subsequently coated with a cannabis or hemp-derived powder.

Unfortunately, known processes for creating infused prerolls can be relatively expensive and inconsistent. Such processes are traditionally manual and labor intensive in nature, which results in higher overall costs. Due to the existence of many different small and individual makers, these traditionally manual infused preroll formation processes also have varying levels of quality assurance and consistency in different batches of infused prerolls, and even from one infused preroll to the next.

Although traditional ways of forming infused prerolls have worked well in the past, improvements are always helpful. In particular, what is desired are infused preroll formation systems and methods that provide greater levels of automation to result in lower manufacturing costs and greater quality assurance and consistency in finished infused preroll products.

### SUMMARY

It is an advantage of the present disclosure to provide lower infused preroll formation costs and greater quality assurance and consistency in finished infused preroll products. The disclosed features, apparatuses, systems, and methods relate to the mass manufacture of infused preroll products using greater levels of automation that can include one or more overall machines or systems with various robotically controlled components and machine stages. Such overall machines or systems can include at least an adhesive spraying station or system and a fluidized bed coating station or system, among other overall system components.

In some embodiments, there is a magnetic collet pod that revolutionizes the traditional collet mechanism by introducing a magnetic latch system. This system allows for a more controlled and variable clamping force, achieved by manipulating the strength of the magnetic field. By transitioning to an electromagnet, the strength of the magnetic field, and consequently the clamping force, can be adjusted with precision, allowing for both soft and firm holds as required by the machining operation. In some embodiments, there is a stardust preroll, blunt, or cigarette coating machine that is an automated system designed to efficiently and consistently coat prerolls. Comprising four primary components, this machine streamlines the coating process, ensuring uniformity and precision, and operates at a speed at least three times faster than manual methods. In some embodiments, there is a fluidized bed coating system that is a standalone device designed to coat objects that have been previously sprayed with adhesive, using cannabis-derived or other types of powders. This system incorporates advanced pressure and temperature regulation mechanisms to ensure optimal fluidization conditions, resulting in a uniform and high-quality coating. In some embodiments, there is an artistic preroll design coating machine that is an automated system tailored to apply intricate adhesive designs onto prerolls. These designs, once sprayed, act as a base for the cannabis-derived powder to adhere to, creating visually appealing and unique patterns on the preroll. This system ensures precision, consistency, and offers a novel approach to traditional infused prerolls. In some embodiments, any one of the following may be combined together to form a system or process using the magnetic collet pod as described herein, coating machine to coat prerolled cigarettes as described herein, a fluidized bed coating system as described herein, and/or an artistic preroll design coating machine as described herein.

In various embodiments of the present disclosure, a system configured to process prerolled cigarettes can include one or more prerolled cigarette holders, an adhesive spraying station, and a fluidized bed coating station. Each of the one or more prerolled cigarette holders can be configured to hold a prerolled cigarette therein. The adhesive spraying station can be configured to apply adhesive to one or more prerolled cigarettes held by the one or more prerolled cigarette holders and inserted into the adhesive spraying station. The fluidized bed coating station can be configured to apply a coating to the one or more prerolled cigarettes held by the one or more prerolled cigarette holders after the one or more prerolled cigarettes have had adhesive applied thereto.

In various detailed embodiments, the system can be configured to form cannabis based infused prerolled cigarettes. Operations of the one or more prerolled cigarette holders, the adhesive spraying station, the fluidized bed coating station, or any combination thereof can be performed automatically by one or more system processors. Each of the one or more prerolled cigarette holders can include a collet device configured to hold a prerolled cigarette therein. Each collet device can include an enclosure defining an elongated shape and an enclosure opening at a distal end thereof, a collet situated within the enclosure and configured to accept the prerolled cigarette inserted through the enclosure opening and into the collet, and an internal magnetic component located within the enclosure. The collet can include a collet opening and a plurality of clamping components configured to actuate between an open position to release the prerolled cigarette and a closed position to hold the prerolled cigarette. The internal magnetic component can be configured to facilitate actuation of the collet between the open position and the closed position based on magnetic interactions between the internal magnetic component and a separate external activating magnetic component located outside the collet device and proximate the internal magnetic component. The adhesive spraying station can include an adhesive tank, a spraying chamber, one or more spraying nozzles, and a spraying chamber heating component configured to heat the spraying chamber during a spraying operation. The fluidized bed coating station can include a coating chamber that is removably coupled to a plenum base by way of multiple magnetic pairings.

In further detailed embodiments, the system can also include a prerolled cigarette holder loading station having one or more prerolled cigarette holder start and end locations. The prerolled cigarette loading station can include a top plate having a plurality of prerolled cigarette holder top openings therethrough and one or more floor components with corresponding prerolled cigarette holder floor openings that are configured to move relative to the top plate. The system can also include a robotic arm configured to transport automatically within the system one or more prerolled cigarette holders while one or more prerolled cigarettes are held therein, as well as an end effector coupled to the robotic arm and configured to couple to and control the one or more prerolled cigarette holders. The end effector can be configured to facilitate the simultaneous processing of one or more prerolled cigarettes held by the one or more prerolled cigarette holders at the adhesive spraying station and the fluidized bed coating station.

In further embodiments of the present disclosure, an end effector can include a robotic arm coupling component, one or more collet device coupling components, and one or more activating magnetic components. The robotic arm coupling component can be configured to couple the end effector to a movable end of a robotic arm. Each of the one or more collet device coupling components can be configured to removably couple the end effector to a separate collet device that is configured to hold a separate object therein. Each of the one or more activating magnetic components can be configured to interact with an internal magnetic component located within one of the separate collet devices to facilitate actuation of the separate collet device between an open position and a closed position.

In various detailed embodiments, at least a portion of the one or more activating magnetic components can be electromagnets configured to deliver a variable magnetic field. Each separate collet device can be a prerolled cigarette holder and each separate object can be a prerolled cigarette. The end effector can be configured to facilitate the simultaneous processing of multiple prerolled cigarettes held by multiple prerolled cigarette holders at an adhesive spraying station and a fluidized bed coating station within a system configured to process prerolled cigarettes. In some arrangements, the end effector can include multiple collet device coupling components, and the end effector can also include an end effector plate having an opening therethrough for each separate collet device coupling component, a drive head and mounting pin for each separate collet device coupling component, and a drive component configured to rotate the entire end effector about a central axis thereof such that all collet device coupling components rotate about the central axis. Each drive head and mounting pin can be configured to spin in place along a longitudinal axis thereof to facilitate spinning of a separate collet device coupled to the collet device coupling component.

In further embodiments of the present disclosure, a system configured for the loading and unloading of collet devices can include a top plate and one or more floor components coupled to and located directly adjacent to the top plate. The top plate can have a plurality of collet device top openings therethrough. Each of the one or more floor components can have one or more collet device floor openings and can be configured to move relative to the top plate. An opening movement of each of the one or more floor components can result in collet device floor openings aligning with collet device top openings to allow a separate collet device to pass through simultaneously the top plate and bottom plate. A closing movement of each of the one or more floor components can result in collet device floor openings misaligning with collet device top openings to block the separate collet device from passing through simultaneously the top plate and bottom plate.

In various detailed embodiments, the system can comprise a collet pod loading station located within an overall system configured to process prerolled cigarettes. The collet pod loading station can be located within a recessed window of the overall system configured to process prerolled cigarettes that is accessible to a manual operator without accessing any internal region of the overall system configured to process prerolled cigarettes. The plurality of collet device top openings can be arranged into multiple loading regions, with each loading region forming multiple collet device top openings that are configured to be used for all collet devices being simultaneously coupled to or uncoupled from a separate multiple collet device end effector. Movement of a floor component can be a rotational movement such that each of its collet device floor openings rotates about a floor component center. In some arrangements, the top plate can include a plurality of top plate magnetic components and each floor component can include a plurality of floor component magnetic components. The floor component magnetic components can then interact with the top plate magnetic components during movement of a respective floor component.

In still further embodiments of the present disclosure, a system configured to apply adhesive to prerolled cigarettes can include an adhesive tank, a spraying chamber, one or more spraying nozzles, and a spraying chamber heating component. The adhesive tank can be configured to hold a fluid adhesive material therein. The spraying chamber can be coupled to the adhesive tank, can include a bottom, one or more outer walls, and an upper opening, can define an internal volume, and can be configured to receive one or more prerolled cigarettes inserted into the internal volume during a spraying operation. The adhesive nozzle(s) can be located within the internal volume and can be configured to receive the fluid adhesive material from the adhesive tank and spray the fluid adhesive material onto the one or more prerolled cigarettes inserted into the internal volume during the spraying operation. The spraying chamber heating component can be configured to heat the spraying chamber during the spraying operation.

In various detailed embodiments, the system can comprise an adhesive spraying station located within an overall infused preroll formation system. The fluid adhesive material can include a cannabis based distillate material. The spraying chamber heating component can include an external blanket around the outer walls of the spraying chamber and a heating element configured to heat the external blanket. In some arrangements, heating the spraying chamber during the spraying operation can facilitate increased adhesion of the sprayed fluid adhesive material such that greater amounts of fluid adhesive material adhere to the prerolled cigarette(s) inserted into the internal volume and to various inner surfaces within the spraying chamber.

In further detailed embodiments, the system can include a lid removably coupled to the spraying chamber at the upper opening thereof. The lid can include a plurality of preroll openings therethrough, each of which is configured to receive simultaneously a prerolled cigarette inserted therethrough and into the internal volume. An air distribution component can be located at an outer surface of the lid and configured to deliver air through the lid and into the internal volume at one or more air entry locations. An air nozzle can be coupled to an inner surface of the lid at each of the one or more air entry locations, and each air nozzle can be configured to receive pressurized air from the air distribution component through a respective air entry location and project the pressurized air in a horizontal direction within the internal volume directly beneath the lid. Each air nozzle can be distributed about the lid at an outer circumference thereof. The pressurized air can be projected into a circular or swirling pattern around an upper region of the internal volume such that escape of the sprayed fluid adhesive material through the plurality of preroll openings is prevented or limited. In some arrangements, the one or more adhesive nozzles can include a plurality of adhesive nozzles coupled to and distributed around an upper portion of a central column located at the center of the internal volume. Each of the plurality of adhesive nozzles can be configured to spray the fluid adhesive material outward and away from the central column.

In still further detailed embodiments, the system can include a spraying chamber exit configured to pass air and oversprayed adhesive material from the internal volume to outside the spraying chamber, as well as a plurality of baffles spaced apart within the internal volume between the spraying chamber bottom and the one or more adhesive nozzles. Each of the plurality of baffles can include one or more openings therethrough such that the plurality of baffles and openings therethrough combine to form a complex exit air path from an upper region of the internal volume to the spraying chamber exit. The plurality of baffles can be arranged horizontally, can extend to the one or more outer walls of the spraying chamber, and can be formed from a material that facilitates the adhesion of oversprayed adhesive material on baffle surfaces. The plurality of baffles can be readily removable from the spraying chamber to facilitate the collection of oversprayed adhesive material adhered to the baffle surfaces.

In further embodiments of the present disclosure, methods of applying adhesive to prerolled cigarettes are provided. Pertinent process steps can include inserting one or more prerolled cigarettes into a spraying chamber, heating the spraying chamber to an elevated temperature, delivering a fluid adhesive material from an adhesive tank to the spraying chamber, spraying the fluid adhesive material onto the one or more prerolled cigarettes inserted into the spraying chamber while the spraying chamber is heated to the elevated temperature, and removing the one or more sprayed prerolled cigarettes from the spraying chamber.

In various detailed embodiments, the fluid adhesive material can include a cannabis based distillate material. Heating the spraying chamber to the elevated temperature can facilitate increased adhesion of the sprayed fluid adhesive material such that greater amounts of fluid adhesive material adhere to the one or more prerolled cigarettes and to various inner surfaces within the spraying chamber. Further process steps can include heating the fluid adhesive material prior to spraying the fluid adhesive material, projecting pressurized air into the spraying chamber such that an airflow pattern is created within the spraying chamber, vacuuming air and oversprayed adhesive material from the spraying chamber through a complex exit air path, collecting oversprayed adhesive material from one or more internal surfaces within the spraying chamber, or any combination thereof.

In yet further embodiments of the present disclosure, a collet device configured to hold a separate object can include an enclosure, a collet situated within the enclosure, and an internal magnetic component situated within the enclosure. The enclosure can be configured to house a plurality of internal components and can define an elongated shape having an enclosure opening at a distal end thereof. The collet can be configured to accept a separate object inserted through the enclosure opening and into the collet and can include a collet opening and a plurality of clamping components configured to actuate between an open position to release the separate object and a closed position to hold the separate object. The internal magnetic component can be configured to facilitate actuation of the collet between the open position and the closed position based on magnetic interactions between the internal magnetic component and a separate external activating magnetic component located outside the collet device and proximate the internal magnetic component.

In various detailed embodiments, actuation of the collet can involve pulling the collet laterally inward within the enclosure to achieve the closed position and releasing the collet laterally toward the enclosure opening to achieve the open position. Actuation of the collet to achieve the closed position can be accomplished in varying amounts based on the level of magnetic interaction between the internal magnetic component and the separate external activating magnetic component. The enclosure can include a base section removably coupled to a tapered conical section, and the internal magnetic component can be located within the base section while the collet can be located within the tapered conical section. Actuation of the collet from the open position to the closed position can involve pulling the collet laterally inward within the enclosure such that the plurality of clamping components slide against an inner surface of the tapered conical section that forces the plurality of clamping component to close onto the separate object.

In various further detailed embodiments, the collet device can also include a retention spring located within the enclosure and configured to apply a biasing force against the collet. The biasing force can result in the collet being situated at a default position in the absence of any magnetic interaction between the internal magnetic component and the separate external activating magnetic component. The default position can be the open position and application of a magnetic force by the separate external activating magnetic component can result in overcoming the biasing force to actuate the collet to the closed position. The collet can be part of a collet assembly that includes the plurality of clamping components at a first distal end thereof and an elongated shaft ending at a second distal end thereof opposite the first distal end. The internal magnetic component can be coupled to the elongated shaft at the second distal end. Activation of the separate external activating magnetic component can result in the magnetic interaction with the internal magnetic component pulling the internal magnetic component and the collet assembly toward the separate external activating magnetic component. In some arrangements, the separate external activating magnetic component can be an externally controlled electromagnet, which can be configured to have an adjustable power output to vary a clamping force of the collet. The separate object can be a prerolled cigarette, and the collet device can be part of an overall system configured to handle and treat prerolled cigarettes that further includes a collet device loading station, an adhesive spraying station, and a fluidized bed coating station. The separate external activating magnetic component can be located at and controlled by a robotic arm end effector of the overall system.

In still further embodiments of the present disclosure, methods of handling an object with a collet device are provided. Pertinent process steps can include accepting an object within a collet of a collet device, activating an external activating magnetic component, and actuating the collet. Accepting the object can occur when the collet is in an open position. The collet can include a collet opening that receives the object therethrough and a plurality of clamping components. The external activating magnetic component can be located outside the collet device and proximate an internal magnetic component located within the collet device. The collet can be actuated from the open position to a closed position based on a magnetic interaction between the actuated external activating magnetic component and the internal magnetic component. The closed position can involve the plurality of clamping components moving radially inward to clamp onto and hold the object accepted therein.

In various detailed embodiments, each step can be automatically performed by the collet device or a processing component controlling the external activating magnetic component. Actuating the collet can include pulling the internal magnetic component toward the external activating magnetic component. Additional process steps can include deactivating the external activating magnetic component, actuating the collet from the closed position to the open position based on removal of the magnetic interaction between the actuated external activating magnetic component and the internal magnetic component, and releasing the object from the collet. Another process step can involve adjusting the power of the external activating magnetic component, which can result in adjusting the strength of the magnetic interaction between the actuated external activating magnetic component and the internal magnetic component. Adjusting the strength of the magnetic interaction can then result in adjusting a clamping force exerted by the plurality of clamping components.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures, arrangements, systems, and methods of use for prerolled cigarette handling and treatment/processing systems. Such systems can include adhesive spraying stations, fluidized bed coating stations, and other system components for the handling and treatment or processing of infused prerolls and other forms of prerolled cigarettes. These drawings in no way limit any changes in form and detail that may be made to the disclosure by one skilled in the art without departing from the spirit and scope of the disclosure.

FIG. 1A illustrates in front perspective view an example system for the handling and treatment of prerolled cigarettes according to one embodiment of the present disclosure.

FIG. 1B illustrates in exploded view an example single magnetic collet device according to one embodiment of the present disclosure.

FIG. 1C illustrates in perspective view an example single collet spray chamber according to one embodiment of the present disclosure.

FIG. 1D illustrates in side elevation view the single collet spray chamber of FIG. 1C according to one embodiment of the present disclosure.

FIG. 1E illustrates in perspective view an example single collet dipping chamber according to one embodiment of the present disclosure.

FIG. 1F illustrates in side cross-section view the single collet dipping chamber of FIG. 1E according to one embodiment of the present disclosure.

FIG. 2A illustrates in front perspective view an example system for the handling and treatment of prerolled cigarettes using a multiple collet arrangement according to one embodiment of the present disclosure.

FIG. 2B illustrates in rear elevation view the prerolled cigarette handling and treatment system of FIG. 2A according to one embodiment of the present disclosure.

FIG. 3 illustrates a flowchart of an example summary method of forming an infused preroll cigarette according to one embodiment of the present disclosure.

FIG. 4A illustrates in side perspective view an example multiple collet pod end effector for a prerolled cigarette handling system according to one embodiment of the present disclosure.

FIG. 4B illustrates in side perspective view the end effector of FIG. 4A coupled to the moving end of a robotic arm and located well beneath a collet pod loading station according to one embodiment of the present disclosure.

FIG. 4C illustrates in side perspective view the end effector of FIG. 4B moved up to interact with the collet pod loading station to receive multiple collet pods therefrom according to one embodiment of the present disclosure.

FIG. 4D illustrates in side perspective view the end effector of FIG. 4C with multiple collet pods coupled thereto and moved downward from the collet pod loading station according to one embodiment of the present disclosure.

FIG. 4E illustrates in side perspective view the end effector and multiple collet pods of FIG. 4D as moved away from the collet pod loading station and turned upside down for treatment or processing held prerolls at an adhesive spraying station and a fluidized bed coating station according to one embodiment of the present disclosure.

FIG. 5A illustrates in top perspective view an example collet pod loading station for a prerolled cigarette handling system according to one embodiment of the present disclosure.

FIG. 5B illustrates in front perspective view the collet pod loading station of FIG. 5A installed within a prerolled cigarette handling system and having filled and empty collet pod locations according to one embodiment of the present disclosure.

FIG. 5C illustrates in front perspective view the collet pod loading station of FIG. 5B with further filled collet pod locations according to one embodiment of the present disclosure.

FIG. 5D illustrates in top perspective view the collet pod loading station of FIG. 5C with further filled collet pod locations and a user manually removing collet pods therefrom according to one embodiment of the present disclosure.

FIG. 5E illustrates in top plan view an example loading region for a collet pod loading station with its floor component rotated to an open position according to one embodiment of the present disclosure.

FIG. 5F illustrates in top plan view the loading region of FIG. 5E with the floor component rotated to a closed position according to one embodiment of the present disclosure.

FIG. 6A illustrates in front perspective view various components of an example multiple collet adhesive spraying station for a prerolled cigarette handling system according to one embodiment of the present disclosure.

FIG. 6B illustrates in top rear perspective view the adhesive spraying station of FIG. 6A according to one embodiment of the present disclosure.

FIG. 6C illustrates in side perspective view an example removable lid for the adhesive spraying station of FIG. 6B according to one embodiment of the present disclosure.

FIG. 6D illustrates in bottom perspective view the removable lid of FIG. 6C according to one embodiment of the present disclosure.

FIG. 6E illustrates in top perspective view an example spraying chamber for the adhesive spraying station of FIG. 6B with its lid removed according to one embodiment of the present disclosure.

FIG. 6F illustrates in side perspective view an example baffle arrangement for the spraying chamber of FIG. 6E according to one embodiment of the present disclosure.

FIG. 6G illustrates in side perspective view the baffle arrangement of FIG. 6F with a top baffle removed according to one embodiment of the present disclosure.

FIG. 6H illustrates in side elevation view the baffle arrangement of FIG. 6F according to one embodiment of the present disclosure.

FIG. 7 illustrates a flowchart of an example detailed method of applying adhesive to prerolled cigarettes according to one embodiment of the present disclosure.

FIG. 8A illustrates in top rear perspective view an example multiple collet fluidized bed coating station within a prerolled cigarette handling system according to one embodiment of the present disclosure.

FIG. 8B illustrates in top perspective view the fluidized bed coating station of FIG. 8A according to one embodiment of the present disclosure.

FIG. 8C illustrates in top perspective view an example plenum base for the fluidized bed coating station of FIG. 8A according to one embodiment of the present disclosure.

FIG. 8D illustrates in bottom perspective view an example removable fluidized coating chamber for the fluidized bed coating station of FIG. 8A according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of the specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, and methods for forming prerolled cigarettes, and in particular infused preroll products. The disclosed embodiments involve the use of automated systems and components configured to handle and process prerolled cigarettes to improve existing prerolls into infused prerolls. This can include the application of powdered kief or other cannabinoid material to form an external coating onto prerolled joints, blunts, dogwalkers, or other similar preroll products. The disclosed prerolled cigarette handling systems can include a system enclosure or chassis, one or more collet pods for handling prerolls, a robotic arm, an adhesive spraying station, and a fluidized bed coating station, among other possible system components and stations.

Although various embodiments disclosed herein primarily discuss infused prerolls and prerolled cigarettes, it will be readily appreciated that the disclosed features, apparatuses, systems, and methods can similarly be with any suitable substitute or alternative items or materials that take advantage of the disclosed features. For example, the disclosed systems and methods can be used for the formation and handling of cigars, tobacco based products, or other inhalation devices or products. Other applications, arrangements, and extrapolations beyond the illustrated embodiments are also contemplated.

### Prerolled Cigarette Handling Systems

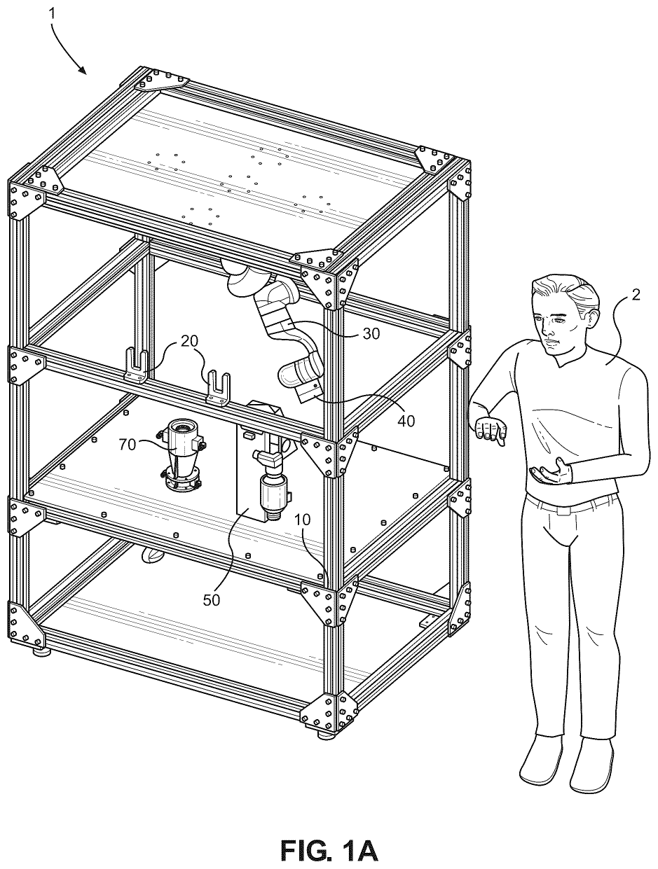

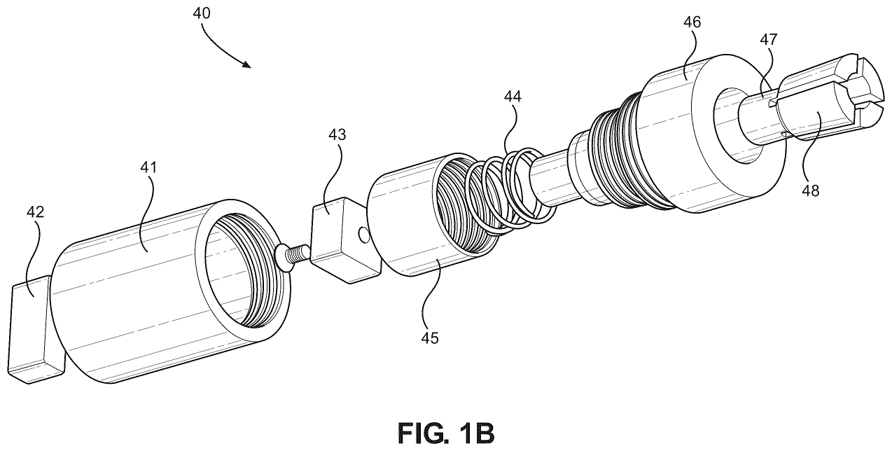

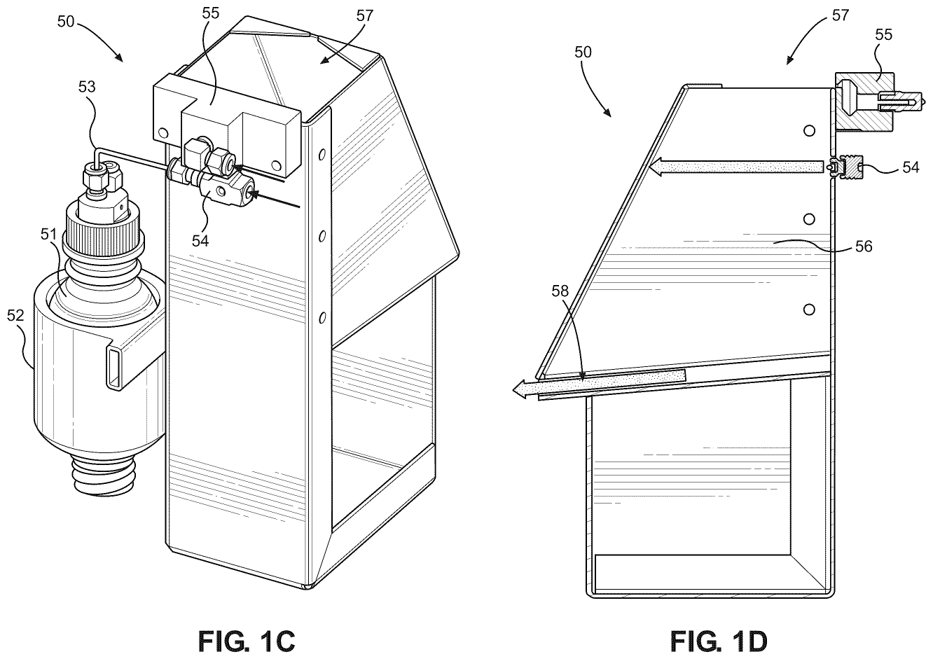

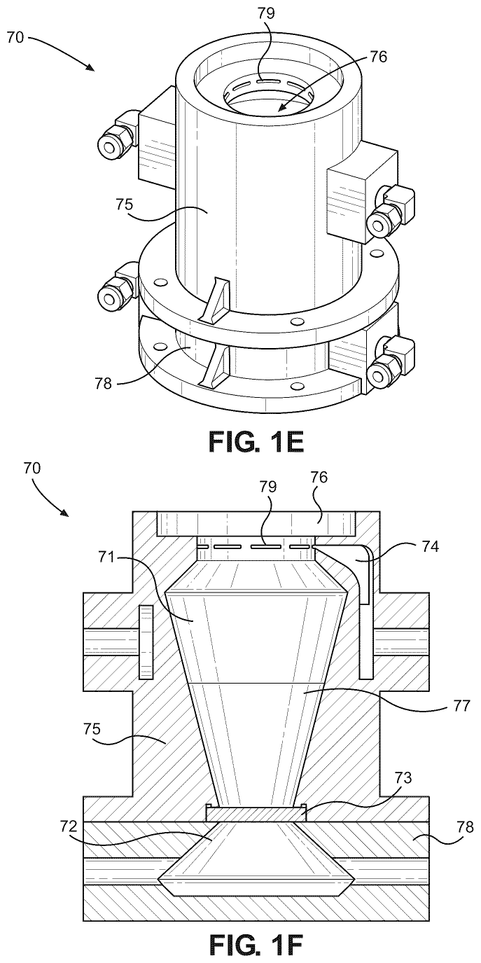

Referring first to FIGS. 1A-1F, one example of a prerolled cigarette handling system and various components thereof are illustrated. It will be readily appreciated that this system and its various components provide just some examples of systems for handling and treatment or other processing of prerolls (i.e., prerolled cigarettes), and that further examples, extrapolations, and alternatives are also possible, some of which are provided below. FIG. 1A illustrates in front perspective view an example system for the handling and treatment of prerolled cigarettes. Prerolled cigarette handling system 1 can include a system chassis 10 (e.g., framework), one or more collet pod start/end locations 20, a robotic arm 30 configured for collet pod transport, a collet pod 40, an adhesive spraying station 50, and a fluidized bed coating station 70, among other possible stations and components. Other components can include, for example, one or more enclosures (not shown) and/or shelves located about or across chassis 10. A human operator 2 is shown since some aspects of system 1 may benefit from manual supervision or interaction. For example, human operator may be responsible for placing and removing prerolls from start/end location 20. Human operator 2 can also indicate the general size or scale of system 1, although it will be readily appreciated that this system can be smaller or larger according to various designs.

In some arrangements, prerolled cigarette handling system 1 can also be referred to as a “Stardust” system or a “Preroll, Blunt, or Cigarette Coating Machine,” among other names or terminologies. This prerolled cigarette handling system 1 can be an automated system designed to efficiently and consistently coat prerolls. Prerolled cigarette handling system 1 can offer a groundbreaking solution to traditional manual methods of producing infused prerolls. By automating the process, it ensures consistency, precision, and efficiency, meeting the growing demand for high-quality infused prerolls in the hemp, cannabis, and tobacco industries. Comprising four primary components, this system 1 can streamline the coating process, ensure uniformity and precision, and operate at a speed at least three times faster than traditional manual methods. These four primary components can include a collet pod, an adhesive spraying station, a kief application station, and an exit station, or their equivalents, as noted below.

Collet Pod 40: Can be a device designed to securely hold a preroll during a coating process and can be singularly attached to a robotic arm end effector. Alternatively, multiple collet pods can be magnetically or mechanically attached to the robotic arm. For instance, eight or ten collet pods, each containing a preroll, can be magnetically attached to an end effector.

Adhesive Spraying Station 50: Once the prerolls are secured in the collet pods, a robotic arm can transport them to the adhesive spraying station. Here, the prerolls can be sprayed with the chosen adhesive, either individually or collectively. Each collet pod can be rotated, controlled by a stepper motor, ensuring even application of the adhesive.

Kief Application Station 70: Post adhesive application, the robotic arm can move the prerolls to the kief application station. This station can feature an annular or linear fluidized bed of cannabis-derived powder. The fluidization ensures that the adhesive-coated prerolls receive a consistent, single-layer coating of kief. Similar to the spraying station, each collet pod can rotate, but in this station the entire array of collet pods can rotate in unison.

Exit Station 20: After the coating process, the prerolls, still in their collet pods, can be transported to the exit station. Here, they can be ejected into a designated bin or directly into final packaging, ready for distribution.

FIG. 1B illustrates in exploded view an example single collet pod 40 or magnetic collet device. Collets have been a cornerstone in the manufacturing and machining industry for a significant period. Historically, collets are mechanical devices that form a collar around a workpiece or tool to be held and exert a strong clamping force on an item when tightened, usually by means of a tapered outer collar. The primary function of a collet is to accurately and securely hold a workpiece or tool in place during a machining operation, such as drilling or milling. Traditional collets operate on a principle of mechanical deformation. The radial deformation is achieved by the action of a threaded device or a crank mechanism. This mechanical action forces the collet to contract around the workpiece or tool, holding it in place. The degree of tightness or clamping force is directly proportional to the mechanical force applied, which often lacks precision and can result in either too much or too little force being applied to the workpiece or tool.

The “Magnetic Collet Pod” of the various systems disclosed herein can revolutionize the traditional collet mechanism by introducing a magnetic latch system or arrangement. This system allows for a more controlled and variable clamping force, achieved by manipulating the strength of the magnetic field. By transitioning to an electromagnet, the strength of the magnetic field, and consequently the clamping force, can be adjusted with precision, allowing for both soft and firm holds as required by a machining or other handling operation.

The disclosed collet pod 40 can include a collet situated within a tapered cone that forms part of an overall enclosure. The base of collet pod 40 can include a base section 41 that can be coupled to an external activating magnet 42. Further components can include an internal latch magnet or other internal magnetic component 43, retention spring 44, spring housing 45, tapered conical section 46, and flexible collet insert 47, among other possible components. Base section 41 can be removably coupled to tapered conical section 46 to form an overall enclosure for collet pod 40. Tapered conical section 46 can also be removably coupled to spring housing 45, as shown.

The flexible collet insert (i.e., “collet”) 47 can include a plurality of clamping components 48, such as four clamping components as shown, configured to move radially outward to an open position to release a separate object and radially inward to a closed position to hold the separate object. Retention spring 44 or other spring mechanism can ensure that collet 47 remains in an open position by default. External activating magnet 42 can be positioned to interact with internal latch magnet 43 (or another suitable magnetic component or material) coupled to collet 47. Attraction between these magnets can then pull the collet 47, causing it to radially deform and clamp onto the workpiece, tool, or other item. Such an item can be a preroll inserted into the collet 47, for example.

The configuration of collet pod 40 can be adjusted to be either normally closed (default clamped position) or normally open (default unclamped position). The choice between using a permanent magnet or a magnetic material for the internal magnet provides flexibility in design and function. Similarly, external activating magnet 42 located outside base section 41 or overall collet pod enclosure proximate internal magnetic component 43 can also be either a magnet or a magnetic material. One aspect of the collet assembly for collet pod 40 lies in the ability to control the clamping force with precision. By varying the strength of the magnetic field, the clamping force can be adjusted to the exact requirements of a given operation or item holding function, ensuring optimal performance and preventing or limiting damage to the workpiece, tool, or other item, such as a preroll. As disclosed, this “Magnetic Collet Pod” offers a novel approach to the traditional collet mechanism, providing enhanced control, precision, and flexibility in machining or item handling operations. The integration of magnetic principles into the collet design paves the way for more efficient and adaptable manufacturing processes.

FIG. 1C illustrates in perspective view an example single collet spray chamber, while FIG. 1D illustrates in side elevation view the single collet spray chamber of FIG. 1C. In various embodiments, an adhesive spraying station 50 can take the form of a single collet spray chamber as shown in FIGS. 1C and 1D. Adhesive spraying station 50 can include adhesive tank 51, tank heating component 52, distillate siphon 53, delivery nozzle 54, air curtain delivery 55, and spray chamber 56, among other possible components and features.

In some arrangements, adhesive tank 51, tank heating component 52, and distillate siphon 53 can form a Jiko Heated Reservoir System by Sorting Robotics of Los Angeles, California. Adhesive tank 51 can be configured to hold a fluid adhesive material therein, which can include a cannabis based distillate material, for example. Tank heating component 52 can be configured to hold and heat adhesive tank 51 such that the fluid adhesive material delivered therefrom is heated. Distillate siphon 53 can be configured to deliver heated fluid adhesive, which can include a cannabis based distillate, to delivery nozzle 54, which can then deliver the heated adhesive material into spray chamber 56.

Spray chamber 56 can be a sheet metal box (e.g., 14 gauge sheet metal) supported by a sheet metal base (e.g., 11 gauge sheet metal), for example, and can be configured to receive a single collet holding a single preroll through a top opening 57 therein and into an inner volume of the spray chamber. Delivery nozzle 54 can atomize and spray the heated fluid adhesive through a back wall of spray chamber 56 and onto the preroll inserted into the inner volume. In some embodiments, delivery nozzle 54 can combine warm air from a separate feed with the heated fluid adhesive before providing an atomized flat spray of the combination into spray chamber 56. This can result in an air knife containing distillate vapor that is printed or sprayed onto the preroll in a controlled manner. Air curtain delivery 57 can provide a warm air curtain into spray chamber 56 at a strategic location and direction, such as directly above delivery nozzle 54. A distillate drain 58 feature located along a bottom portion of spray chamber 56 can facilitate collecting excess distillate for recycling and later use.

In some arrangements, adhesive spraying station 50 can be or can form part of an “Artistic Preroll Design Coating Machine,” which can be an automated system tailored to apply intricate adhesive designs onto prerolls. These designs, once sprayed, can act as a base for a cannabis-derived powder to later adhere to, creating visually appealing and unique patterns on the preroll. This automated system can ensure precision, consistency, and offers a novel approach to traditional infused prerolls. By automating the design application and ensuring precision, this system can allow for the creation of visually appealing and unique prerolls, catering to a niche market within the hemp, cannabis, and tobacco industries that values both aesthetics and quality.

As noted above, a collet pod can be designed to securely hold a preroll during the design application process, and such a collet pod can be singularly attached to the robotic arm's end effector. Multiple collet pods can also be magnetically or mechanically attached to the robotic arm, allowing for batch processing. The preroll(s), once secured in the collet pod(s), can be transported to a specialized Design Adhesive Spraying Station. Here, using advanced nozzle technology and programmable patterns, the chosen adhesive can be sprayed onto the prerolls in intricate designs. Each collet pod can rotate, controlled by a stepper motor, ensuring even and precise application of a given adhesive design. After the adhesive design application, the robotic arm can move the prerolls to a Cannabis-Derived Powder Application Station. This station can be equipped with a fluidized bed of cannabis-derived powder to ensure that the adhesive-coated design areas receive a consistent coating of powder, bringing the artistic design to life. Post design and powder applications, the preroll(s) can then be transported to an Exit Station where they can be ejected into a designated bin or directly into final packaging, showcasing their unique, artistic designs.

FIG. 1E illustrates in perspective view an example single collet dipping chamber, while FIG. 1F illustrates in side cross-section view the single collet dipping chamber of FIG. 1E. In various embodiments, fluidized bed coating station 70, which can be a kief application station, can take the form of a single collet dipping chamber as shown in FIGS. 1E and 1F. As noted above, traditional methods of applying external powders to form infused prerolls have often lacked precision and efficiency. As such, the “Stardust Preroll, Blunt, or Cigarette Coating Machine” disclosed herein provides an automated system for this purpose. In particular, the fluidized bed component (i.e. coating chamber 71) can be used for enhancing its capabilities and offering a standalone solution for powder coating. As such, this fluidized bed coating station 70 or “Fluidized Bed Coating System” can be a standalone device designed to coat objects that have been previously sprayed with adhesive, using cannabis-derived or other types of powders. This system can incorporate advanced pressure and temperature regulation mechanisms to ensure optimal fluidization conditions, resulting in a uniform and high-quality coating.

Fluidized bed coating station 70 can include coating chamber 71, plenum 72, sintered bed filter 73, and air curtain delivery 74, among other possible components and features. Coating chamber 71 can be a hollow inner volume formed within a chamber housing 75 in some arrangements. Coating chamber 71 can be configured to hold a fluidized coating material therein, which can include kief or another cannabis based powder in fluidized form, for example. As such, coating chamber 71 can also be called a kiefing chamber. Coating chamber 71 can be configured to receive a single collet holding a single preroll through a top opening 76 therein and into its inner volume such that the preroll can be dipped into fluidized coating material forming a bed up to fill line 77 within the coating chamber.

Plenum 72 can be a hollow inner volume formed within a plenum housing 78 in some arrangements. Fluidized powder can be flowed through plenum 72 by way of flow passages and can enter coating chamber 71 through sintered bed filter 73. One or more O-rings or other suitable sealing components can be used to facilitate a proper seal at sintered bed filter 73 to prevent or limit the loss of fluidized powder. The kief or any other suitable powder can be maintained in a fluidized state by way of controlled pressure, temperature, and flows, as will be readily appreciated. Plenum housing 78 can be mechanically coupled to chamber housing 75 in an upper direction and to a shelf, table, or other foundational item in a lower direction, such as by way of M6 bolts or any other suitable coupling arrangement.

Air curtain delivery 74 can provide a horizontal air curtain through openings 79 around a narrowed ledge toward the top of coating chamber 71, as shown. Warm pressurized air can be flowed through air curtain delivery 74 by way of flow passages from one or more inlets to these openings 79, which can be located around the inner circumference of the narrowed ledge. This horizontal air curtain and narrowed ledge can limit the amount of powder that escapes from coating chamber 71 during a dipping and coating process. The air curtain can also serve to dislodge loose powder from and secure adhered powder to an infused preroll as it is being removed from coating chamber 71 after dipping and coating.

As will be readily appreciated, fluidized bed coating station 70 can also include a pressure regulation system and a temperature regulation system for the fluidized powder material. The pressure regulation system can be integrated into the system, machine, or system, and can ensure that the air pressure within the fluidized bed chamber is maintained at optimal levels. Proper pressure can ensure that the powder remains in a fluidized state, allowing for even coating of the introduced objects. The temperature regulation system can be used to recognize the importance of temperature in achieving proper fluidization, and as such can be equipped with advanced temperature control mechanisms. These mechanisms can monitor and adjust the temperature within the chamber, ensuring that it remains within the desired range for optimal fluidization and coating.

Objects, such as prerolls, previously sprayed with adhesive can be introduced into the fluidized bed chamber. Due to the optimal pressure and temperature conditions, the powder in the chamber can remain in a fluidized state and allow the prerolls or other objects to be evenly coated as they pass through. After the coating process, the prerolls or other objects can be transported out of the fluidized bed chamber. An integrated exit and collection system can ensure that any excess powder is captured and recycled, minimizing waste and ensuring efficiency. This fluidized bed coating station 70 or any other suitable “Fluidized Bed Coating System” can offer a specialized solution for those seeking a precise and efficient method of coating objects with cannabis-derived or other powders. With its advanced pressure and temperature regulation mechanisms, such a system can ensure optimal fluidization conditions, leading to high-quality and consistent results.

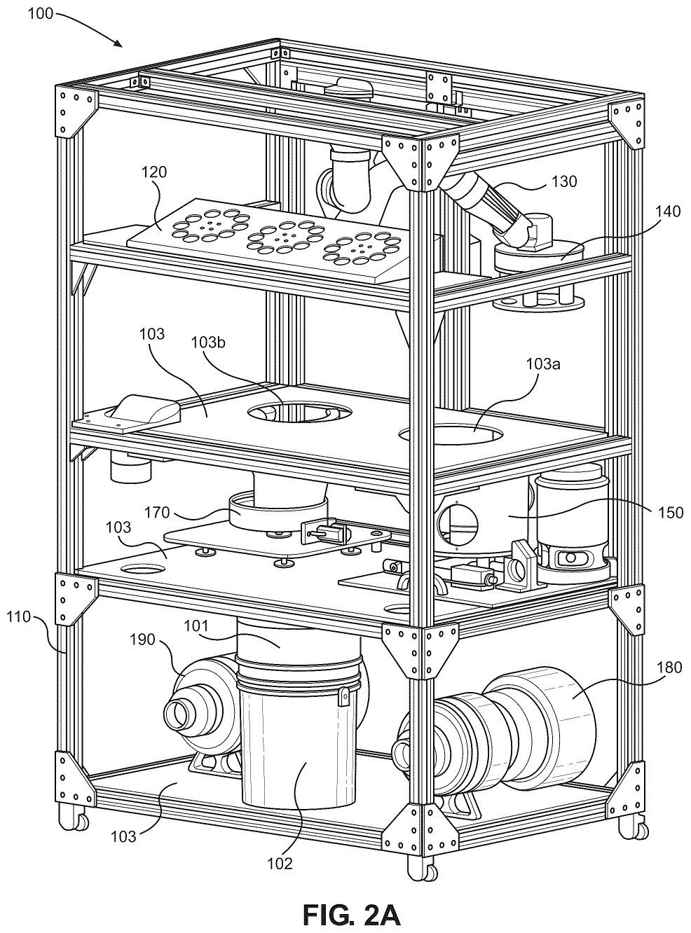

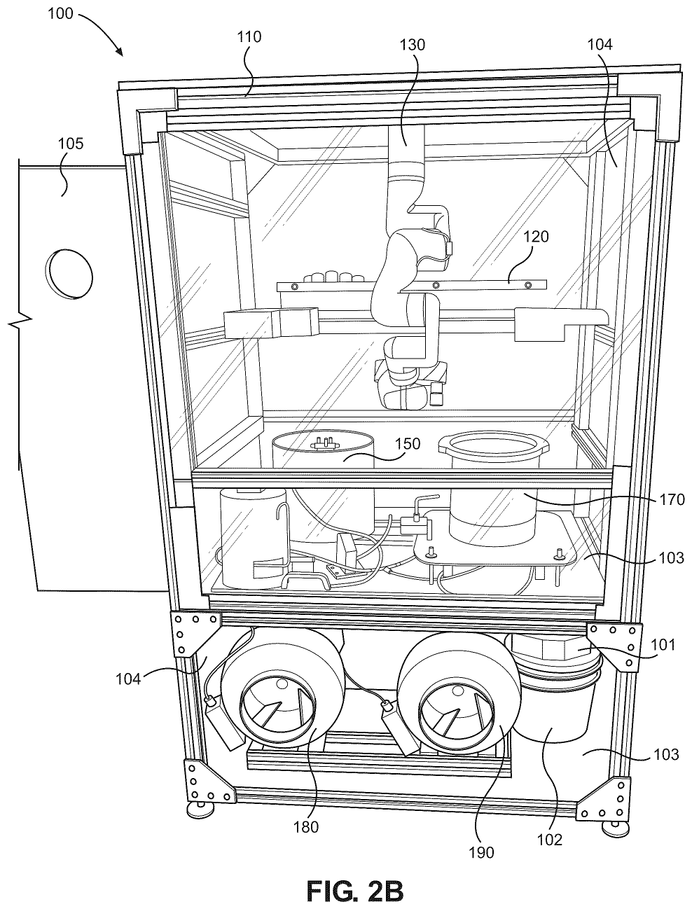

Transitioning now to FIGS. 2A and 2B, an example system for the handling and treatment of prerolled cigarettes using a multiple collet arrangement is illustrated in front perspective and rear elevation views respectively. Infused preroll formation system 100 can be similar to prerolled cigarette handling system 1 illustrated and described above in that both systems can be configured to take prerolled cigarettes (i.e., prerolls) and process them into infused prerolls. Infused preroll formation system 100 can have various stations and components that are similar to system 10 above, with many of these stations and components being altered to be able to accommodate the processing of multiple prerolls at a time. This can be done using a multiple collet arrangement rather than a single collet arrangement, for example, as well as upgraded or otherwise altered stations and other components to accommodate multiple preroll handling and processing and provide improved functions, as set forth in greater detail below.

Infused preroll formation system 100 can include a system framework or chassis 110, a collet pod loading station 120 having multiple collet pod start/end locations, a robotic arm 130 configured for multiple collet pod transport, a multiple collet pod end effector 140 coupled to the robotic arm, an adhesive spraying station 150 configured for applying adhesive to multiple prerolls simultaneously, a fluidized bed coating station 170 configured for applying a coating to multiple prerolls simultaneously, an adhesive vacuum manifold 180 configured to facilitate operations of the adhesive spraying station, and a coating vacuum manifold 190 configured to facilitate operations of the fluidized bed coating station, among other possible stations and components.

Other components of infused preroll formation system 100 can include, for example, a dust separator 101 and collection bucket 102 coupled to coating vacuum manifold 190 and configured for the collection and recycling of powder for fluidized bed coating station 170, a similar arrangement (not shown) coupled to adhesive vacuum manifold 180 and configured for the collection and recycling of adhesive material from adhesive spraying station 150, one or more shelves 103 located about or across chassis 100 and configured to support various stations and components, one or more enclosures 104 located about chassis and configured to form contained ambient environment(s) around the entire system and/or various internal portions thereof, and an air circulation box 105 configured to provide airflows within the entire system and/or various sections thereof, among other possible system components, such as chassis wheels, air and fluid tubing and connections, electrical connections, processing components, internal heaters, cameras, pressure sensors, temperature sensors, and other feedback sensors, and the like.

In some arrangements, various openings and connections can be made in shelves 103 or other chassis and system components to facilitate access. For example, one shelf 103 can have opening 103a therethrough for robotic arm 130 and end effector 140 to be able to access adhesive spraying station 150, and also opening 103b for the robotic arm and end effector to be able to access fluidized bed coating station 170. Some enclosures 104 or portions thereof may have openings, windows, or hinged doors formed therein to facilitate access as well. For example, one or more enclosures 104 on the back of chassis 110 may form hinged doors that can open to provide access to system components and that can close during system operations. One or more enclosures can result in forming an entire enclosed internal area, which internal area can be heated with one or more internal heaters during handling and processing operations, such as to 50° C. It will be readily appreciated that some components and features have been removed from one or both of FIGS. 2A and 2B and that some are shown at alternative possible locations for purposes of illustration. Other system component and feature locations are also possible.

Like prerolled cigarette handling system 1 illustrated and described above, infused preroll formation system 100 can also be configured to accept prerolls at a start location, handle each preroll using a dedicated magnetic collet pod, move each preroll to an adhesive spraying station where adhesive is applied, move each sprayed preroll to a coating station where a coating is applied, and move each coated (i.e., infused) preroll to an end location, which end location can also be the start location. In system 1, system 100, and other similar machines and systems, a sophisticated robotic arm can be used to facilitate automatically some or all of these basic process steps. Robotic arm 130 can be identical or substantially similar to robotic arm 30 in system 1 above, or it can be more a complex robotic arm and/or programmed differently due to further features and complexities of system 100 and its expanded capabilities.

In various embodiments, robotic arm 130 can be configured to facilitate all automated movement, handling, and processing of collet pods and prerolls held therein while these items are within any processing station or any enclosed region within infused preroll formation system 100. As will be readily appreciated, robotic arm 130 can include a fixed end coupled to a ceiling or other fixed portion of system chassis 110, a movable end coupled to end effector 140 and configured to move through multiple degrees of freedom relative to the fixed end, and multiple movable arm segments between the fixed end and the movable end. Each movable arm segment can be coupled in series at both of its ends to the fixed end, another movable arm segment, or the movable end of robotic arm 130, and each coupling can provide for rotational movement between a given movable arm segment and its neighbors on both ends thereof.

As will be readily appreciated, various degrees of freedom of movement can be obtained by using enough movable arm segments on robotic arm 130. By including six movable arm segments, for example, six degrees of freedom for the overall movement of robotic arm 130 can be obtained. This can allow for the precise lateral and vertical positioning, orientation, and direction of movement for its movable end and thus end effector 140 coupled thereto. Robotic arm 130 can be controlled by one or more general or dedicated processors that can be located on or within the robotic arm, at a location within or about system 100, remotely, or any combination thereof. In various embodiments, robotic arm 130 can be a model Xarm6 robotic arm made by Ufactory of Shenzhen, China, or a model RS007N robotic arm made by Kawasaki Robotics of Wixom, Michigan, for example, although any other suitable robotic arm could also be used for the disclosed infused preroll formation system 100 or other similar system. Other functions and arrangements for a robotic arm are also possible.

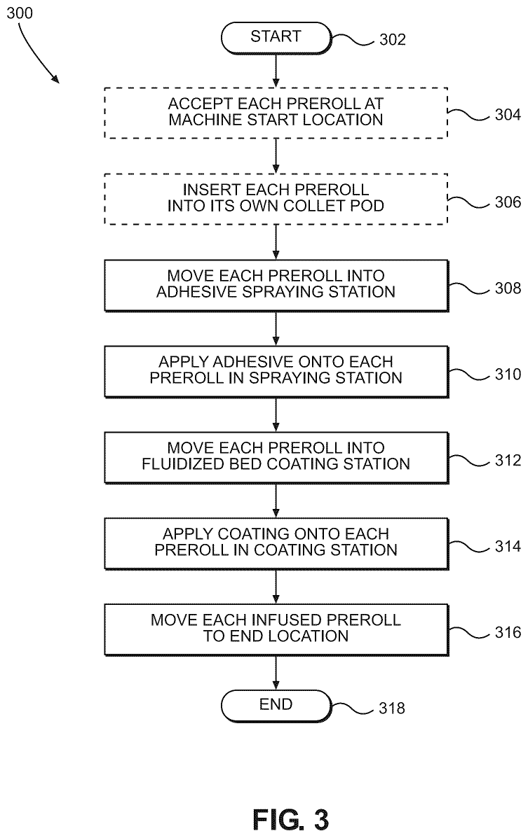

Continuing with FIG. 3, a flowchart of an example summary method of forming an infused preroll cigarette is provided. It will be readily appreciated that summary method 300 can be a high level method such that one or more steps can be omitted, various other steps can be added, and/or the order of steps can be altered as may be desired. Method 300 can be performed on one or more existing preroll cigarettes to turn each one into one or more infused preroll cigarettes. In some arrangements the method can be performed partially or entirely automated, such as by prerolled cigarette handling system 1 as disclosed above for a single preroll at a time, infused preroll formation system 100 as disclosed above for multiple prerolls simultaneously, or by any other similarly suitable machine or system. It will also be appreciated that summary method 300 can be extrapolated to apply to other machines or systems, as well as to other preroll products such as cigars, blunts, dogwalkers, and the like.

After a start step 302, an optional first process step 304 can involve accepting each preroll at a machine or system start location. This can include, for example, accepting one or more prerolls at a suitable machine or system start/end location such as those illustrated above. Placing each preroll into a respective start location can be performed manually by a system operator or can be automated by way or one or more sensors and robotic components. Step 304 of accepting each preroll can be automatically performed by a prerolled cigarette handling machine or system, such as by way of a specifically arranged accepting component.

A subsequent optional process step 306 can involve inserting each preroll into its own collet pod. This can include, for example, inserting the correct end of each preroll into a collet pod and then tightening the collet around the inserted preroll until it is held firmly in place. This can be done for a single preroll or for multiple prerolls, such as by insertion into a multi-collet end effector arrangement. Step 306 can be automatically performed by a prerolled cigarette handling machine or system, such as by way of a specifically programmed robotic arm or other robotic component configured to grip a preroll and manipulate the gripped preroll into a collet pod, as well as automated actuation of a magnetic arrangement to facilitate tightening the collet.

At process step 308, each preroll can then be moved into an adhesive spraying station. This can involve moving one or more prerolls that have been inserted into and held in place within a collet for greater ease in handling. Each preroll held in such a manner can have a sufficient portion thereof extending out from the collet for processing on its exterior surfaces. Step 308 can be automatically performed by a prerolled cigarette handling machine or system, such as by way of a specifically programmed robotic arm or other robotic component configured to move each collet and held preroll arrangement into the adhesive spraying station. This can involve an end effector coupled to the robotic arm and configured to facilitate the handling of single or multiple preroll and collet arrangements.

At a following process step 310, adhesive can be sprayed onto each preroll within the adhesive spraying station. The adhesive can be an atomized spray sourced and delivered from, for example, a tank of fluid adhesive material that includes a cannabis based distillate material. In some arrangements, adhesive can be sprayed from a nozzle onto the outer surface of a preroll that has been located in close proximity to the nozzle, and there can be one dedicated spraying nozzle for each preroll inserted into the adhesive spraying station. Step 310 can be automatically performed by a prerolled cigarette handling machine or system, such as by way of a specifically programmed adhesive spraying station with associated robotically controlled components.

At the next process step 312, each preroll can then be moved from the adhesive spraying station into a fluidized bed coating station. This can involve moving the preroll(s) that have sprayed with adhesive and are still within their respective collet(s), and each preroll again can have a sufficient portion thereof extending out from the collet for further processing on its exterior surfaces. Step 312 can be automatically performed by a prerolled cigarette handling machine or system, such as by way of the previously noted specifically programmed robotic arm or other robotic component configured to move each collet and held preroll arrangement from station to station, and again can involve an end effector coupled to the robotic arm and configured to facilitate the handling of single or multiple preroll and collet arrangements.

At the next process step 314, a coating can be applied onto each preroll within the fluidized bed coating station. This can involve, for example, dipping each preroll that has been sprayed with adhesive into the fluidized bed coating station. Such a coating station can hold a chosen powder, such as a cannabis derived powder, for example, within a fluidized bed chamber under optimal pressure and temperature conditions such that the powder remains in a fluidized state within the chamber. Again, this can allow each of the adhesive sprayed prerolls to be evenly coated with the fluidized powder while they are within the chamber, which can then result in the formation of an infused preroll from each original preroll. Step 314 can be automatically performed by a prerolled cigarette handling machine or system, such as by way of a specifically programmed fluidized bed coating station with associated robotically controlled components.

At the next process step 316, each now infused preroll can be moved to a machine or system end location. In some arrangements, such an end location can be the same as the start location, and this end location can be configured to allow for removal of the infused prerolls from the machine or system. Step 316 can be automatically performed by a prerolled cigarette handling machine or system, such as by way of the previously noted specifically programmed robotic arm or other robotic component configured to move each collet and held preroll arrangement from station to station, which again can involve a suitable end effector as noted above. The method can then end at end step 318.

In various embodiments, some steps can be performed simultaneously. For example, steps 304 and 306 can be performed at the same time. In addition, not all steps may be needed for some methods, and the order of steps can be altered as may be practical or optimal for a given process. Additional steps or functions can also be included as may be desired. For example, specific robotic movement of preroll and collet arrangements during adhesive spraying can result in aesthetically pleasing patterns of adhesive applied onto a preroll. Further steps can involve collection of oversprayed adhesive for recycling and reuse on later preroll sprayings. Other steps can involve functional details regarding sensors, feedback, communications, and other processor functions. Further examples of additional steps and functions can be determined and extrapolated from the various items, features, and details provided below.

Additional details will now be provided for various major components and processing stations specific to infused preroll formation system 100. These include a multiple collet pod end effector, a collet pod loading station, an adhesive spraying station or system, and a fluidized bed coating station or system.

### Multiple Collet Pod End Effector

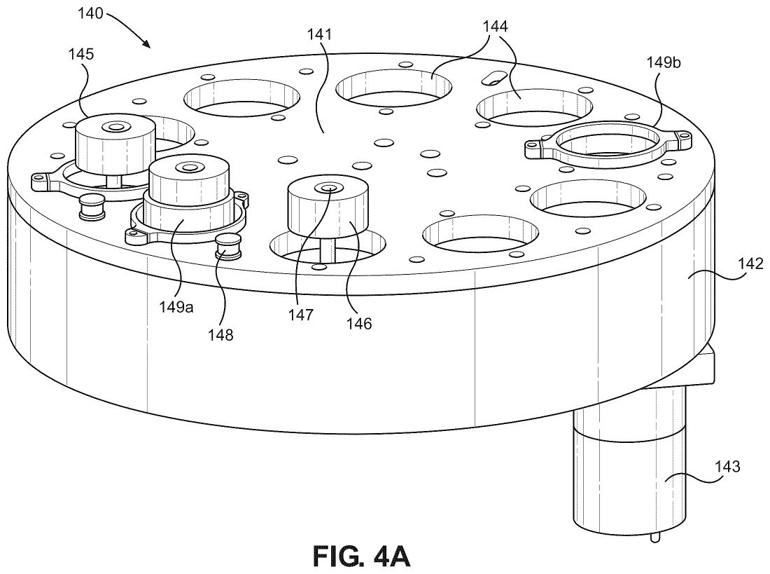

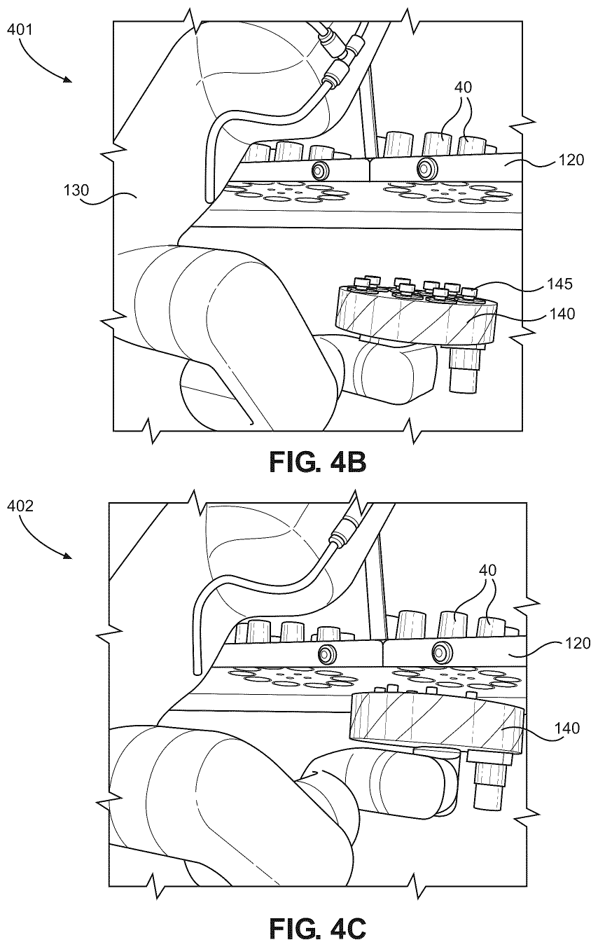

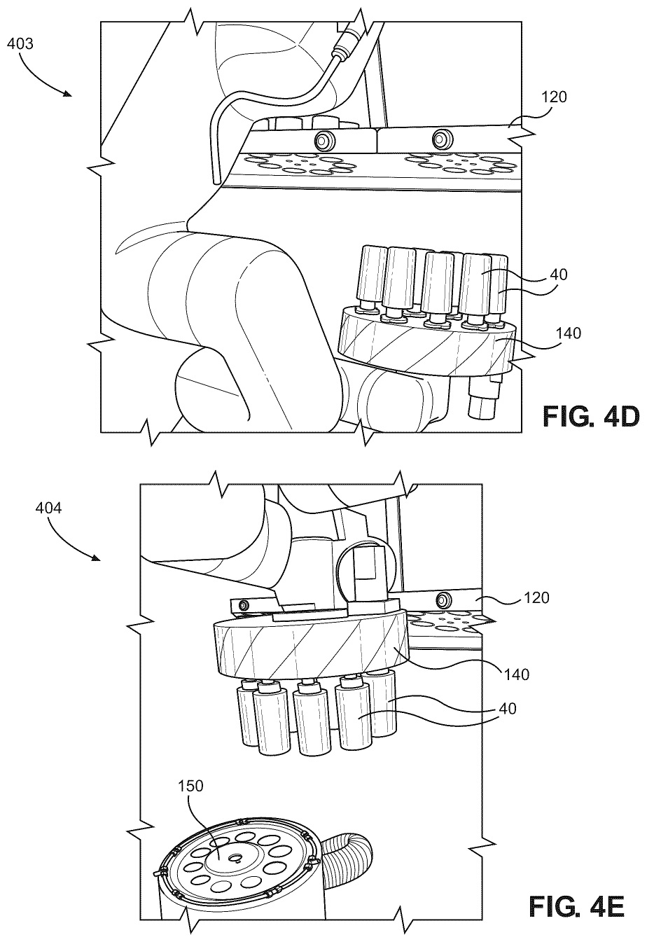

Moving next to FIG. 4A, an example multiple collet pod end effector for a prerolled cigarette handling system is illustrated in side perspective view. As shown, multiple collet pod end effector 140 can be configured for handling ten collet pods, although more or fewer collet pods can be handled by this end effector or any similar component. Multiple collet pod end effector 140 can include end effector plate 141 coupled atop an outer housing 142 with various internal components inside. A gear motor 143 or other suitable drive component can be coupled to an obverse side of end effector 140 using a motor plate and can facilitate operation of various internal components, such as external magnet movement and powering. A robotic arm coupling component (not shown) can also be coupled to the obverse side of end effector 140 to couple the end effector to a moving end of the robotic arm, and such a coupling component can be arranged to facilitate rotation of the entire end effector with respect to the robotic arm moving end.

End effector plate 141 can have openings 144 therethrough for each separate collet pod to be handled. Although some openings 144 are shown with fewer parts or features for purposes of illustration, it will be appreciated that each opening can be identical or substantially similar to be able to handle many interchangeable separate collet pods. Each opening 144 can have a drive head 145 extending therethrough, with each drive head including a magnet 146 coupled to a mounting pin or screw 147. As shown, openings 144 and their respective drive heads 145 can be arranged in a circle about a center point of end effector plate 141 such that rotation of the end effector about an axis through this center point results in the openings and drive heads rotating along this circle. Although openings 144 are shown as being arranged in a circular formation, it will be understood that other types of arrangements and formations can also be used. For example, such openings for collet pods can be arranged in a straight line in some embodiments, such as where a system spraying station, fluidized coating bed station, or both are arranged conducive to straight line arrangements rather than annulus arrangements.

Each magnet 146 can be a neodymium magnet, for example, which can be configured to exert a variable magnetic force to interact with a magnetic component in a coupled collet pod. Mounting pin or screw 147 can be configured to rotate such that its respective magnet 146 rotates in place, which will then rotate a coupled collet pod and thus any preroll held therein. One or more idlers 148 can be used to control each drive head 145. A drive adapter 149a and bearing retainer 149b can be used to limit rotation and movement of each drive head 145 as well as to keep the drive head aligned and in place. The rotational or “spin” speed for each drive head 145 can be controlled by way of a motor and control software in the system. Some arrangements can involve all drive heads 145 (and thus all coupled collet pods) being moved in sync by way of a timing belt driven by motor 143. Alternatively, a gear drive system can be used rather than a timing belt. In other arrangements, each drive adapter 149a can be a single motor drive system such that drive heads 145 can be individually or separately controlled.

Continuing with FIGS. 4B through 4E, the foregoing multiple collet pod end effector is shown as coupled to a robotic arm in different positions during routine collet pod handling and processing operations within an enclosed environment inside an overall infused preroll formation system. FIG. 4B illustrates in side perspective view the end effector of FIG. 4A coupled to the moving end of a robotic arm and located well beneath a collet pod loading station. As shown in position 401, end effector 140 is coupled to robotic arm 130 and is in an upright position such that multiple drive heads 145 extend from openings at an upper surface of the end effector. End effector 140 is beneath and well below collet pod loading station 120, which has numerous collet pods 40 held at an upper surface thereof. These held positions for collet pods 40 can represent start positions or locations for the overall machine, system, or infused preroll formation process. Although collet pods 40 are shown as being empty for purposes of illustration in FIGS. 4B through 4E, it will be readily appreciated that some or all of these collet pods can have a preroll gripped and held therein for each of the different positions.

FIG. 4C illustrates in side perspective view the end effector of FIG. 4B moved up to interact with the collet pod loading station to receive multiple collet pods therefrom. As shown in position 402, end effector 140 has been moved upward by robotic arm 130 to engage with a lower or floor region of collet pod loading station 120. In various embodiments, this lower or floor region can be within an enclosed environment of the infused preroll formation system while the upper surface of collet pod loading station 120 is outside of the enclosed environment. One or more suitably shaped and configured enclosure components can provide for such an inside and outside enclosed environment arrangement. When end effector 140 suitably engages with a given floor component at the underside of collet pod loading station 120, then robotic arm 130 can rotate the end effector about a center point on its top end effector plate such that all drive heads atop the end effector rotate in a circular manner. As a result of this rotation, end effector 140 can rotate the floor component such that all collet pods 40 located at a region associated with the floor component fall through the collet pod loading station and couple to drive heads on the end effector. Some or all of such engagements, rotations, and coupling actions of collet pods to drive heads on end effector 140 can be facilitated by way of magnetic components and magnetic attraction forces, as set forth in greater detail below.

FIG. 4D illustrates in side perspective view the end effector of FIG. 4C with multiple collet pods coupled thereto and moved downward from the collet pod loading station. As shown in position 403, robotic arm 130 has moved end effector 140 downward from collet pod loading station 120 after all of the collet pods 40 have fallen through their respective locations atop the loading station and coupled to the drive heads atop the end effector. Each such coupling between a collet pod 40 and a drive head atop end effector 140 can be a magnetic coupling, such as where an external activating magnet inside the drive head interacts with an internal magnetic component within a base section of the collet pod, as detailed above.

It will be readily appreciated that the same motions and actions in reverse can return collet pods 40 to the top of collet pod loading station 120, where they can arrive at end positions or locations. As will be readily appreciated, an end position for a collet pod can reflect the location of a collet pod holding an infused preroll that now has an outer coating. Such end locations for each collect pod can be the same or substantially similar to the start locations at the start of an infused preroll handling and formation process. In various arrangements, shearing forces created by the rotation of end effector 140 while interacting with a floor component of collet pod loading station 120 can break a magnetically enforced alignment of the floor component with a top plate of the loading station such that the floor component can then be rotated to an open or closed position with respect to openings in the top plate.

FIG. 4E illustrates in side perspective view the end effector and multiple collet pods of FIG. 4D as moved away from the collet pod loading station and turned upside down for processing held prerolls at an adhesive spraying station and a fluidized bed coating station. As shown in position 404, robotic arm 130 has moved away from collet pod loading station 120 and inverted itself, end effector 140, and collet pods 40 in preparation for insertion into openings at the top of adhesive spraying station 150. Again, although not shown, prerolls can be held by and extend downward from each collet pod 40. From position 404 as shown, robotic arm 130 can continue to move end effector 140, its held collet pods 40, and the prerolls held therein laterally over until all are directly above adhesive spraying station 150. At that point, everything can be lowered vertically until the prerolls are inserted into the lid openings atop the adhesive spraying station and into a spraying chamber below the lid for spraying adhesive onto the prerolls.

After treatment at adhesive spraying station 150, robotic arm 130 can then similarly pull vertically upward end effector 120, held collet pods 40, and the sprayed prerolls held therein and move everything laterally over to the fluidized bed coating station. Similar robotic arm 130 movements can result in dipping the sprayed prerolls vertically downward into the coating station for coating treatment, pulling the sprayed prerolls vertically upward, reinverting the entire assembly with the now coated infused prerolls held in the collet pods, and lateral movement to below collet pod loading station 120. Collet pods 40 holding the infused prerolls can then be moved upward through the openings in loading station 120 until the collet pods and infused prerolls are at the start/end locations above the loading station, as noted above.

### Collet Pod Loading Station

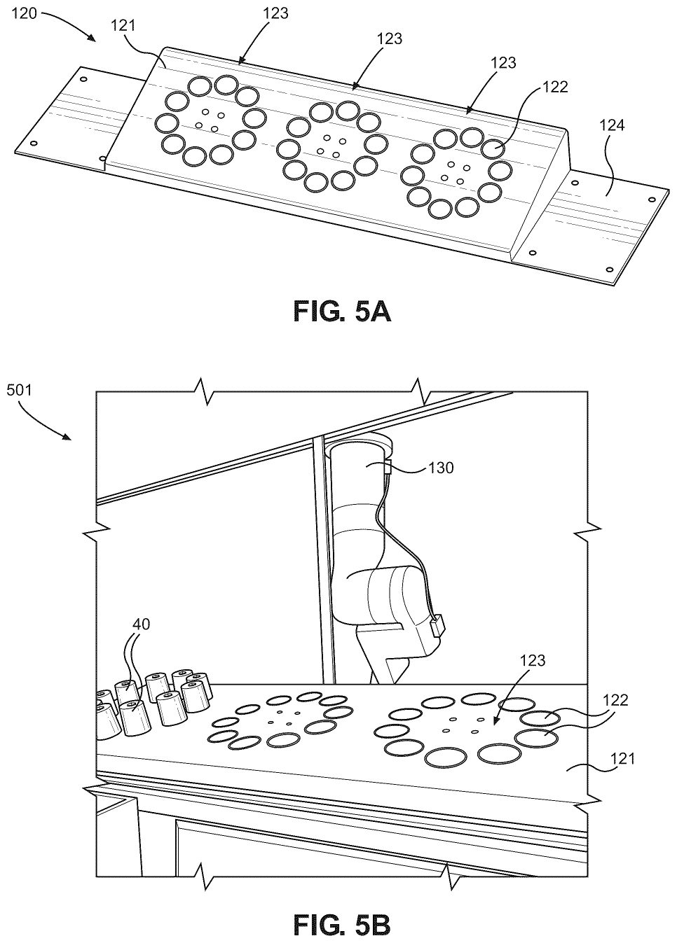

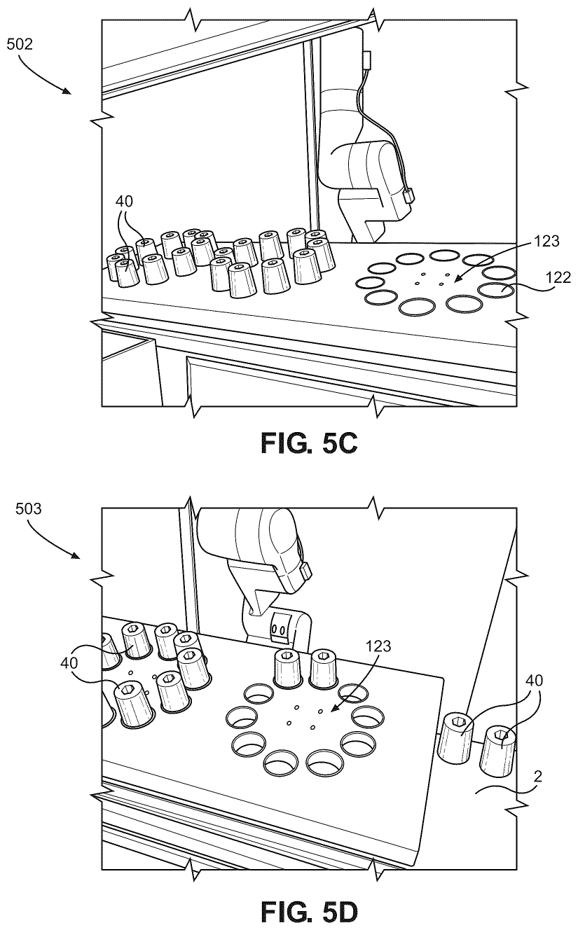

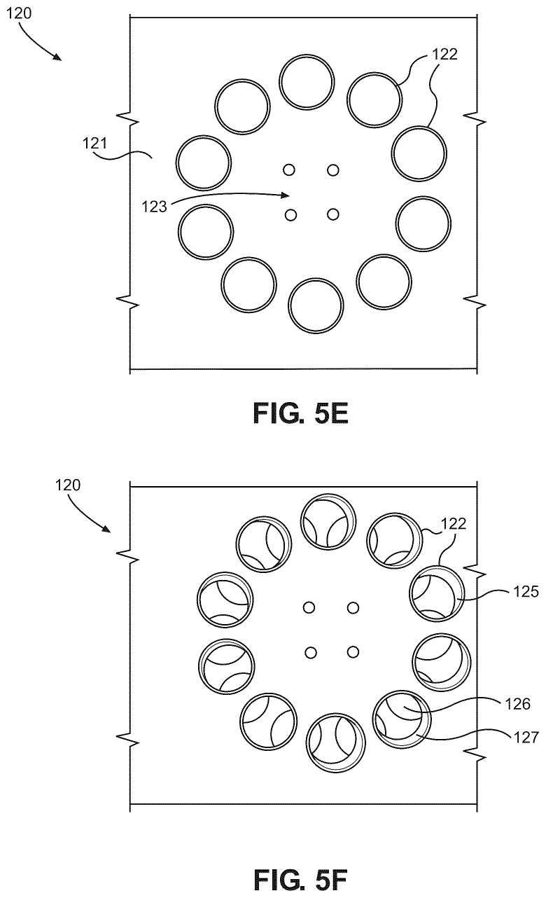

Moving next to FIG. 5A, an example collet pod loading station for a prerolled cigarette handling system is shown in top perspective view. Collet pod loading station 120 can provide multiple collet pod start and end locations for an infused preroll formation system. In some arrangements, each location can serve as a start and end location for a given collet pod for entering and exiting the system. Collet pods can be manually placed into and removed from the various start and end locations, such as by a human operator. Alternatively, or in addition, one or more separate robotic systems or components can be used to place and/or remove collet pods from the various collet pod start and end locations. Prerolls can be inserted into collet pods before the collet pods are placed into start locations or while they are at start locations. Infused prerolls can be removed from collet pods while they are at end locations or after the collet pods have been removed from the end locations. Such insertion and removal of prerolls can also be performed manually and/or by way of separate robotic systems or components.

Collet pod loading station 120 can include top plate 121 having a plurality of top collet pod openings 122 therethrough, and each top collet pod opening can form part of a start and end location for a collet pod. Top plate 121 can be formed from sheet metal or any other suitable material. Top collet pod openings 122 can be arranged into multiple loading regions 123, such as three different loading regions as shown. Of course, more or fewer loading regions can be used for a given loading station. Each loading region 123 have multiple top collet pod openings 122 arranged in a circle or other suitable formation, such as ten openings in a given loading region. Of course, more or fewer openings 122 can be used for a given loading region. Top plate 121 can be arranged such that openings 122 and loading regions 123 are tilted forward toward a user or other robotic component configured to interact with collet pods held at each of the openings (i.e., collet pod start/end locations). Coupling portions 124 can be located along top plate 121 to facilitate coupling collet pod loading station 120 to the rest of an overall infused preroll formation system. Such coupling portions 124 can be integrally formed with or otherwise coupled to top plate 121. One or more movable floor components (not shown) can be located beneath top plate 121, such as one floor component at each loading region 123, details for which are provided in greater detail below.

FIG. 5B illustrates in front perspective view the collet pod loading station of FIG. 5A installed within a prerolled cigarette handling system and having filled and empty collet pod locations. In various embodiments, collet pod loading station 120 can be located within a manually accessible window or region that is outside of an enclosed environment for an overall prerolled cigarette handling system while most other stations and items within the system are within the enclosed environment. In some arrangements, one or more flexible or movable membranes or flaps (not shown) can be used at each top collet pod opening (i.e., start/end location) beneath top plate 121 to limit the flow of air between regions outside and inside the enclosed system environment. As shown in arrangement 501 of FIG. 5B, collet pods 40 can be located at all top collet pod openings 122 of a far left loading region 123 on top plate 121 while the other two loading regions are empty.

FIG. 5C illustrates in front perspective view the collet pod loading station of FIG. 5B with further filled collet pod locations. As shown in arrangement 502 of FIG. 5C, collet pods 40 can be located at all top collet pod openings 122 of far left and middle loading regions 123 on top plate 121 while the far right loading region is empty. Although all collet pods 40 are shown as being empty, it will be understood that each collet pod can instead be holding a preroll or infused preroll that protrudes through a top opening of the collet pod. In addition to membranes or flaps configured to limit airflow through openings 122 into or out of the internal closed environment, these and/or other features can also provide safety arrangements such that a human operator or other component is unable to access internal regions of the overall system during the loading or unloading of collet pods 40 from the collet pod loading station.

FIG. 5D illustrates in top perspective view an example region of a collet pod loading station of FIG. 5C with further filled collet pod locations and a user manually removing collet pods therefrom. As shown in arrangement 503 of FIG. 5C, collet pods 40 can be located at all top collet pod openings 122 of far left and middle loading regions 123 on top plate 121 while the far right loading region has two collet pods remaining therein and a human operator 2 manually removing collet pods from the openings in this far right loading region. Again, although shown as empty for purposes of illustration, each collet pod 40 can have a preroll held therein, such as after loading and before being processed through the overall system. Alternatively, each collet pod 40 can have an infused preroll held therein, such as after treatment and before being unloaded from the collet pod and collet pod loading region 120.

Continuing with FIGS. 5E and 5F, an example region of a collet pod loading station is illustrated in top plan view. FIG. 5E depicts example loading region 123 of collet pod loading station 120 with an associated floor component rotated to an open position, while FIG. 5F depicts this loading region with the floor component rotated to a closed position. As shown in FIG. 5E, loading region 123 can be located on a top plate 121 of collet pod loading station 120. With the underlying floor component rotated to an open position, its various floor collet pod openings align with top collet pod openings 122 such that collet pods held therein will fall through both sets of openings and thus through entire collet pod loading station 120. Rotating the floor component in this manner can be accomplished beneath the loading station, such as by a robotic arm and end effector as noted above.

As shown in FIG. 5F, underlying floor component 125 can be rotated to a closed position. This can result in floor collet pod openings 126 in floor component 125 being rotated at misaligned or offset positions relative to top collet pod openings 122, such that blocking regions 127 of the floor component are beneath each top collet pod opening. These blocking regions 127 then prevent a collet pod held in a top collet pod opening 122 from falling all the way through collet pod loading station 120 and into the enclosed environment of the overall handling and treatment or processing system. As shown, floor collet pod openings 126 can be rotated to be halfway between top collet pod openings 122 to achieve a closed position for given loading region 123. Although a simple rotating floor component can be used to achieve the open and closed positions for all start/end locations as shown, it will be readily appreciated that other arrangements with one more alternatively arranged moving floor components are also possible to block and unblock top collet pod openings 122.

In various embodiments, one or more magnetic components at floor component 125 can be indexed to one or more magnets at top plate 121 to facilitate an accurate rotation or other movement of the floor component relative to the top plate. For example, such magnetic components can be located and indexed such that the default position of floor component 125 can be closed to reduce unwanted effects such as to prevent collet pods from falling through the floor component, to limit entry of air into the enclosed interior of the overall machine or system, and to prevent operator fingers or other items from poking into the enclosed interior for safety purposes. A magnetic detent can be used to lock the floor component at fully open and fully closed rotational positions, and other components such as a robotic arm or end effector can be equipped to overcome the locking of this magnetic detent, as will be readily appreciated.

### Adhesive Spray System

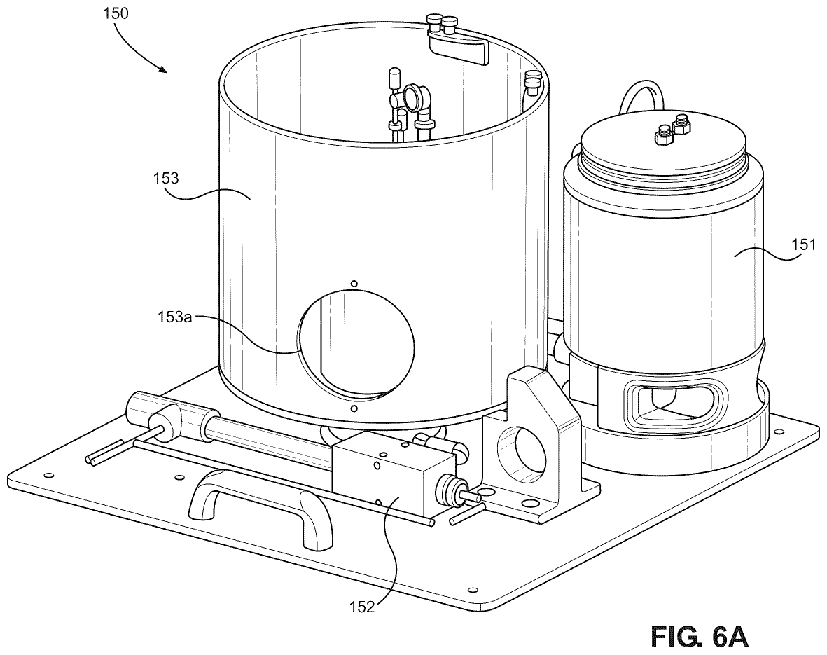

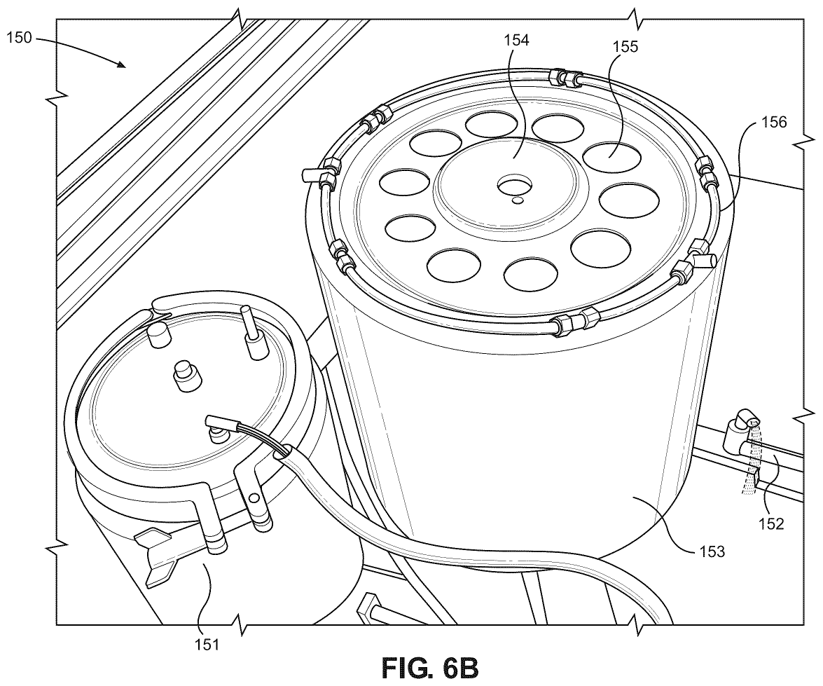

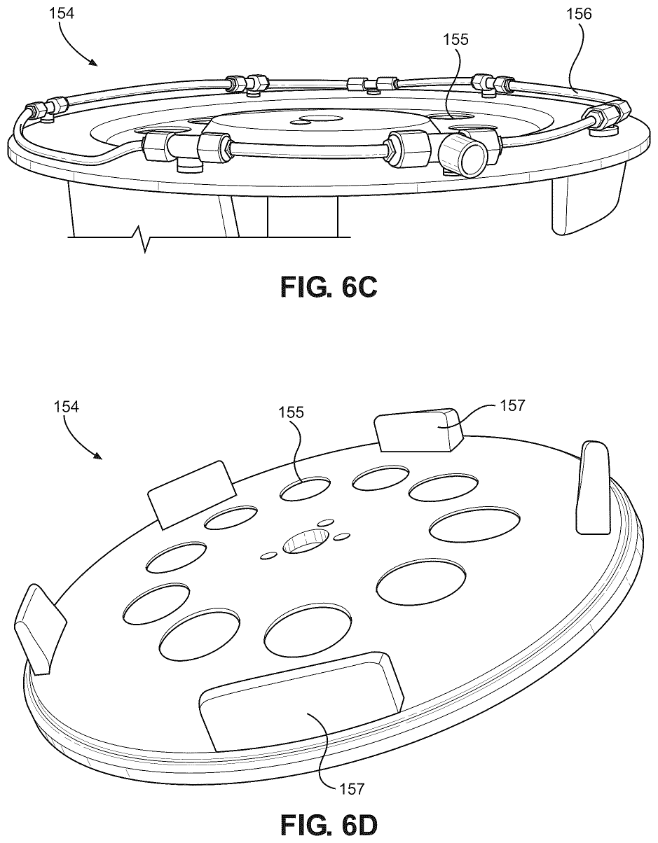

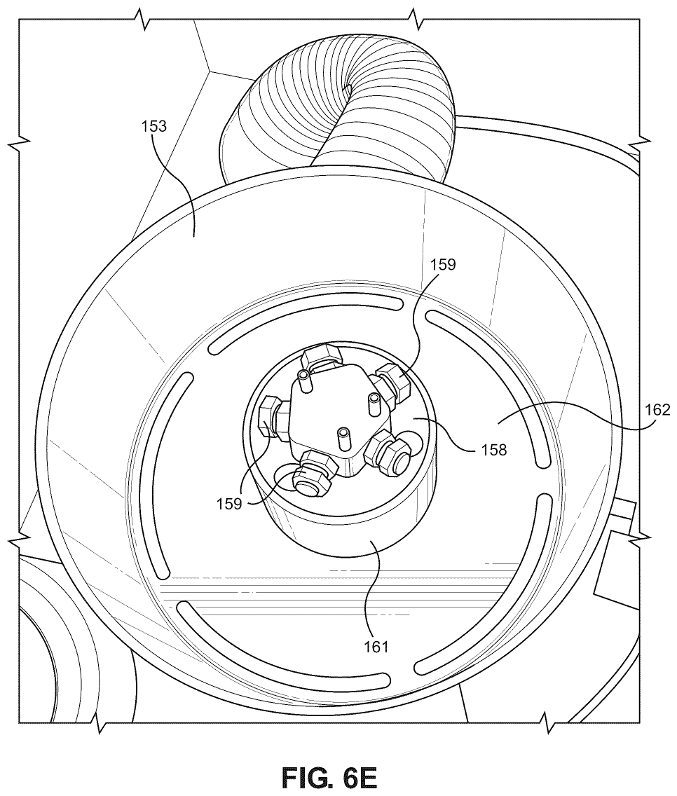

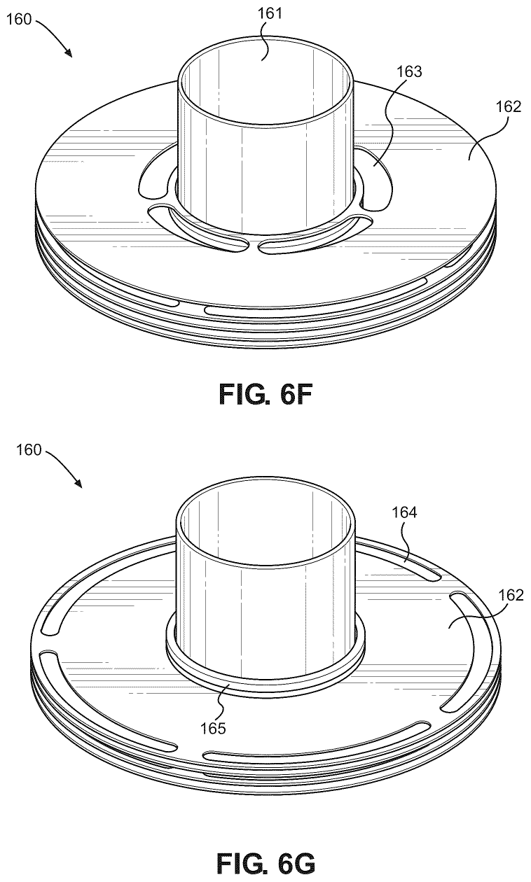

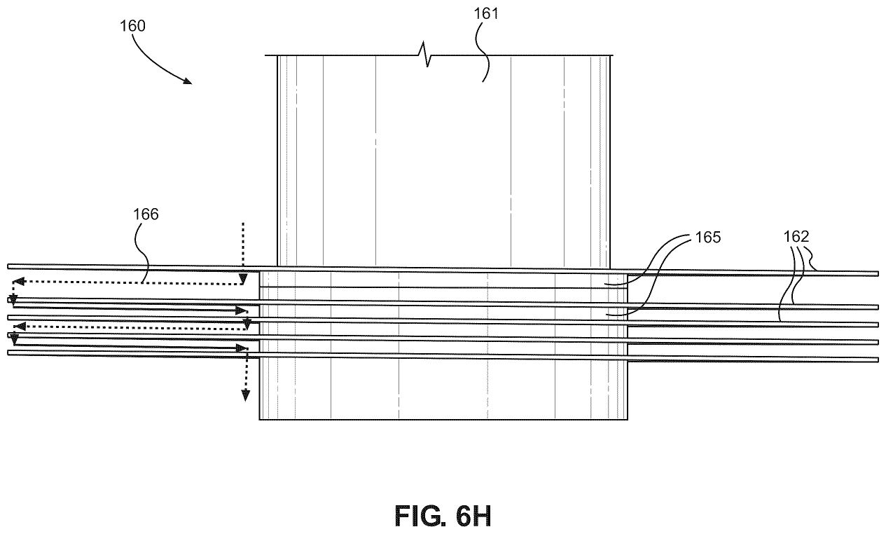

Moving next to FIG. 6A, various components of an example multiple collet adhesive spraying station for a prerolled cigarette handling system are illustrated in front perspective view. It will be understood that some items and features of this adhesive spraying station are not shown in the general front view of FIG. 6A for purposes of illustration. Multiple collet adhesive spraying station 150 can be similar in some regards to adhesive spraying station 50 above for a single collet pod and preroll spraying operation. Adhesive spraying station 150 can include adhesive tank 151, which can be separately heated by a tank heating component (not shown), line heating component 152 located along a delivery line (not shown) from the adhesive tank, and spraying chamber 153, among various other components. Spraying chamber 153 can be a sheet metal cylinder with a floor and removable lid (not shown) and can feature an exit opening 153a along a lower region of a chamber side wall where hot air and excess or oversprayed adhesive material can be removed from the chamber by way of exit tubing (not shown) and a downstream vacuum pump and filter arrangement (not shown). Adhesive spraying station 150 (and various components and items associated therewith) can generally comprise a system configured to apply adhesive to prerolled cigarettes (i.e., prerolls), and can be part of an overall infused preroll formation system.

FIG. 6B illustrates in top rear perspective view the adhesive spraying station of FIG. 6A. Again, adhesive spraying station 150 can include adhesive tank 151, line heating component 152, and spraying chamber 153. Adhesive tank 151 can be configured to hold a fluid adhesive material therein, and this fluid adhesive material can include a cannabis based distillate material or oil in some arrangements. Spraying chamber 153 can be coupled to adhesive tank 151, such as by way of one or more fluid feeding tubes or lines. Spraying chamber 153 can include a bottom, one or more outer walls, such as a singular cylindrically shaped outer wall, and an upper opening, and can also define an internal volume.

Spraying chamber 153 can be configured to receive one or more prerolled cigarettes inserted into its internal volume during a spraying operation. In that regard, adhesive spraying station 150 can also include a removable lid 154 coupled to spraying chamber 153, such as by being placed atop and closing off an upper opening of the spraying chamber. Lid 154 can include a plurality of preroll openings 155 therethrough, and each of these openings can be configured to receive simultaneously a prerolled cigarette inserted therethrough and into the internal volume of spraying chamber 153. Air distribution component 156 can be located at an outer surface of the lid and configured to deliver air through the lid and into the internal volume at one or more air entry locations. A spraying chamber heating component (not shown) can be configured to heat the spraying chamber during the spraying operation, as detailed below.

FIG. 6C illustrates in side perspective view an example removable lid for the adhesive spraying station of FIG. 6B, while FIG. 6D illustrates in bottom perspective view the removable lid of FIG. 6C. Again, removable lid 154 can include preroll openings 155 to allow multiple prerolls to be inserted into the spraying chamber simultaneously, such as by way of a robotic arm and multiple collet pod end effector coupled to collet pods holding the prerolls. As will be readily appreciated, the depth to which prerolls are inserted into spraying chamber 153 can be controlled such that a holding end of the prerolls are not sprayed with adhesive. Depth can be adjusted based on the length of the prerolls being processed. Air distribution component 156 can include air tubing, splitters, and the like located at an upper or outer surface of the lid and configured to deliver pressurized air through one or more air entry locations through the lid, which can be distributed about an outer circumference thereof.

An air nozzle 157 can be coupled to an inner surface of lid 154 at each of the air entry locations, and each air nozzle can be configured to receive pressurized air from air distribution component 156 through a respective air entry location and then project the pressurized air in a horizontal direction within the internal volume directly beneath the lid. In some embodiments, air nozzles 157 can be arranged and oriented such that pressurized air is projected into a circular or swirling pattern around an upper region of the internal volume such that escape of sprayed fluid adhesive material through preroll openings 155 is prevented or limited. This pressurized air delivery can result in swirling effect or circular flow path that provides multiple advantages. One advantage as that this airflow pattern can limit leakage or losses of distillate or other adhesive material through preroll openings 155 of lid 154. In addition, this airflow pattern can force at least a portion of any excess or oversprayed adhesive material against the inner surfaces of the spraying chamber outer wall such that the adhesive material can be recovered later. The pressurized or compressed air delivered by air distribution component 156 and air nozzles 157 can be cold or heated air. In some arrangements, heated air at about 80-100° C. can be used.

FIG. 6E illustrates in top perspective view an example spraying chamber for the adhesive spraying station of FIG. 6B with its lid removed. Central column 158 can be located within spraying chamber 153 at the center of its internal volume, and a plurality of adhesive nozzles 159 can be located within the internal volume and coupled to a nozzle manifold located at the top of the central column. Each of adhesive nozzles 159 can be oriented such that adhesive material is sprayed outward from the central column by the adhesive nozzles. Adhesive nozzle 159 can be arranged in a pattern atop central column 158 such that they are all equal or similar distances from each other. Although five adhesive nozzles 159 are shown, it will be readily appreciated that more or fewer adhesive nozzles can be used in a given arrangement.

Each of adhesive nozzles 159 can be configured to receive fluid adhesive material delivered from the adhesive tank and spray the adhesive material onto prerolled cigarettes inserted into the internal volume during a spraying operation within spraying chamber 153. Such a spraying operation can involve atomizing the adhesive material into a fine mist that is sprayed directly onto a preroll located in front of an adhesive nozzle 159. Where ten prerolls are inserted into spraying chamber 153 for a single spraying operation, five prerolls can be sprayed at the same time by the five adhesive nozzles 159, whereupon the end effector controlling all of the collet pods can then rotate such that the other five prerolls are in front of the nozzles such that the other five prerolls can then be sprayed with the adhesive material. In some arrangements, a spraying operation can also involve each preroll being spun about its own axis by its collet pod such that the entire outer surface is exposed to and evenly sprayed by an adhesive nozzle 159. As also shown in FIG. 6E, a single baffle plate 162 can be coupled to a removable sleeve 161 that is slid around central column 158, further details for which are provided below.

As will be readily appreciated, the use of adhesive material having a cannabis based oil or distillate material can be relatively expensive. As such, it can be desirable to minimize waste of such an expensive adhesive material. In this regard, recovery and recycling of excess or oversprayed adhesive material containing a cannabis based material or component can be useful. Unfortunately, a significant amount of excess or oversprayed cannabis based adhesive material can be lost through ordinary airflow arrangements that involve a spraying chamber exit, exit tubing, and a downstream vacuum pump and filter arrangement. In general, once excess adhesive material reaches a filter or other particulate matter sorting arrangement, the ability to recover such excess adhesive material is mostly or completely lost. Accordingly, various additional components and features can be used with adhesive spraying station 150 to facilitate a greater recovery percentage of excess or oversprayed adhesive material.

One such feature includes the use of one or more heating components to facilitate spraying operations under high temperature conditions. In general, high temperature conditions result in greater adhesion for a hotter and stickier adhesive material, such as a cannabis oil or distillate based material. Such greater adhesion can then result in excess or oversprayed adhesive material sticking to the internal walls of the spraying chamber and also any other components or surfaces located within the spraying chamber or along an exit path out of the spraying chamber. This can be particularly true for atomized adhesive material that is flying or swirling around a heated spraying chamber and/or heated internal components.

Accordingly, adhesive spraying station 150 can also include a spraying chamber heating component configured to heat the spraying chamber during a spraying operation. Such a spraying chamber heating component can be external to spraying chamber, such as an external silicone blanket wrapped around the outer chamber walls that is then heated by a separate heater. Other heating methods are also possible, such as induction heating, or blast air heating directed at the spraying chamber by a fan or other air heater located within an enclosed environment of an overall infused preroll formation system and directed at the spraying chamber. Other types of heating components and methods are also possible to bring the heating chamber to an elevated temperature during an adhesive spraying process.

In some embodiments, the fluid adhesive material itself can be heated at or to about 100-110° C. before being sprayed, such as by an adhesive tank heater, a delivery line heater, or both. The spraying chamber can then be heated to about 70% of the temperature of the sprayed adhesive material, such as about 70° C. for example, since higher temperatures can lead to degradation of the adhesive material during an atomization and spraying process. If a spraying operation is done under temperatures that are too cold, however, then the atomized adhesive particles will not demystify well and this will result in lower adhesion of the sprayed adhesive material. The subject prerolls are then not coated as well, and any excess or oversprayed adhesive material is not recovered as well.

In addition to being able to recover excess or oversprayed adhesive material from the inner surfaces of the spraying chamber walls, it can be advantageous to provide additional items and surfaces within the spraying chamber to allow for greater recovery of the excess adhesive material. In particular, a specifically designed baffle system can be used to force hot air and heated excess adhesive material to travel through a complex exit air path exposed to an increased amount of surface area such that adhesive material flowing toward the spraying chamber exit is more likely to stick to any of these extra surfaces along the way. Such a baffle system or other added parts or components within the spraying chamber can be designed to be easily removable from the chamber or system so as to facilitate recovery of adhesive material stuck to its walls, such as by placing into a separate oven for liquifying, collecting, and recycling the excess or oversprayed adhesive material. By using a heated spraying chamber with a swirling hot air delivery pattern and a baffle arrangement, the recovery and recycling rate of excess or oversprayed adhesive distillate material can reach up to 97% or more.

FIG. 6F illustrates in side perspective view an example baffle arrangement for the spraying chamber of FIG. 6E. Baffle arrangement 160 can include a removable sleeve 161 and a plurality of flat baffle plates 162 stacked up around the removable sleeve. Baffle plates 162 can be spaced apart and can extend from removable sleeve 161 to the outer wall of the spraying chamber. Removable sleeve 161 can be dimensioned to fit around the central column inside the internal volume of the spraying chamber and can be configured to be readily slid onto and removed from the central column. Each baffle plate 162 can have multiple openings situated therethrough, such as inner openings 163 around an inner circumference of the baffle plate in the case of the top baffle plate as shown.

FIG. 6G illustrates in side perspective view the baffle arrangement of FIG. 6F with a top baffle removed. In general, baffle arrangement 160 can be designed such that hot air and heated excess adhesive material is forced to travel through a tortured or complex exit air bath across many extra surfaces from the spraying chamber to a vacuum out port or spraying chamber exit beneath the baffle arrangement. Baffle plates 162 can serve to demist or deatomize the hot and sticky adhesive material flowing past them, as well as to provide additional surface areas upon which the demystified adhesive material can then stick or adhere to. As shown in FIG. 6G, the second baffle plate 162 below the removed top baffle plate can include multiple outer openings 164 situated around an outer circumference of this baffle plate. Alternating baffle plates 162 in the overall stack can have openings around their outer circumferences and then their inner circumferences to create a complex exit air path for heated adhesive and air to travel through. Although five baffle plates 162 are shown, it will be readily appreciated that more or fewer baffle plates can be used in a given baffle arrangement. Also, multiple baffle plates 162 stacked up in baffle arrangement 160 can be separated by spacers 165 or other spacing features, such as notches along removable sleeve 161.

FIG. 6H illustrates in side elevation view the baffle arrangement of FIG. 6F. As noted above, baffle plates 162 can be arranged with alternating openings therethrough at inner and outer circumferences such that complex exit air path 166 is created for heated air and excess adhesive material to be able to travel to an exit port at or near the bottom of the spraying chamber. Again, this can result in exposing the surface areas of all baffle plates 162 to heated excess adhesive material traveling past, which can result in increased collection of the material. In some embodiments, baffle arrangement 160 can be removed from system 100, placed sideways into a separate oven, and heated such that all adhesive distillate material liquifies and drips off the baffle surfaces into a collection pan or recycling container.

In an alternative embodiment, the baffle arrangement can be configured such that the baffles are angled downward and/or an adhesive recovery path is created such that oversprayed adhesive material can be collected at a collection location at or proximate the bottom of the chamber. In some arrangements, the collected material can then be pumped or siphoned out of the chamber and into a recycling system to be placed back into the adhesive tank. For example, a peristaltic pump, piping, and filter arrangement can be coupled to a collection location at the bottom of the chamber to facilitate the automated collection and recycling of oversprayed adhesive material.

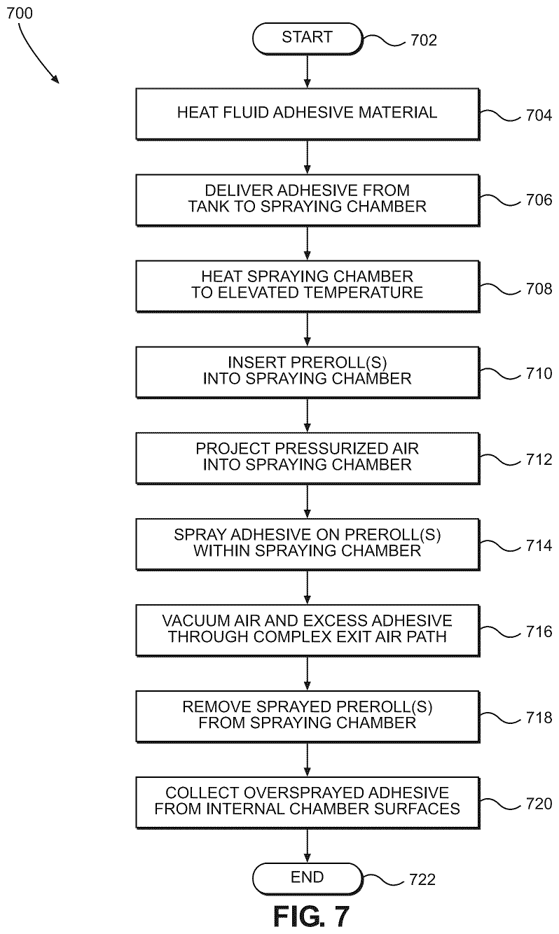

Continuing with FIG. 7, a flowchart of an example detailed method of applying adhesive to prerolled cigarettes is provided. Detailed method 700 can be performed on one or more existing prerolled cigarettes to apply adhesive thereto as part of an overall process to turn each prerolled cigarette into an infused prerolled cigarette. As in the case of summary method 300 above, detailed method 700 can represent steps that can be performed partially or entirely in automated fashion, such as by prerolled cigarette handling system 1 as disclosed above for a single preroll at a time, infused preroll formation system 100 as disclosed above for multiple prerolls simultaneously, or by any other similarly suitable machine or system. Furthermore, it will be understood that not all steps of detailed method 700 need to be performed in a given situation. It will also be appreciated that detailed method 700 can be extrapolated to apply to other machines or systems, as well as to other prerolled products such as cigars, blunts, dogwalkers, and the like.

After a start step 702, a first process step 704 can involve heating fluid adhesive material, which can include a cannabis based distillate material in some arrangements. This heating can take place at a source adhesive tank, along a delivery line or component feeding the fluid adhesive material to a spraying chamber, or both. Process step 704 can be automatically performed, such as by a computer controlled heating component at an adhesive tank, heating component along a delivery line that delivers the fluid adhesive material from a tank to a spraying chamber, or both. This can involve monitoring temperature at one or more given locations and adjusting a heating output in response in a controlled fashion, such as by way of a computer controlled feedback loop. In some arrangements, the fluid adhesive material can be heated to about 100-110° C. before being sprayed.

At a following process step 706, the fluid adhesive material can be delivered from an adhesive tank to a spraying chamber. Process step 706 can be automatically performed, such as by an automatically controlled fluid pump coupled to a delivery line from the adhesive tank to the spraying chamber. This can involve monitoring fluid flow and adjusting a fluid pump output in response to a fluid flow that is too low or too high for desired fluid delivery conditions.

At subsequent process step 708, the spraying chamber can be heated to a specific elevated temperature. This can be done to increase the adhesive properties of the fluid adhesive material such that more of the oversprayed adhesive material can be collected and recycled for reuse in future spraying operations. Process step 708 can be automatically performed, such as by one or more automatically controlled heating components located around an outer surface of the spraying chamber walls and/or within an enclosed region of the overall system and directed at the spraying chamber. In some arrangements, the elevated temperature of the spraying chamber can be about 70% of the temperature of the adhesive being sprayed. For example, the spraying chamber can be heated to about 70° C., for example, since higher temperatures can lead to degradation of the adhesive material.

At the next process step 710, one or more prerolls can be inserted into the spraying chamber. This can involve lowering an end effector controlling multiple collet pods holding multiple prerolls such that the prerolls are lowered through openings in a spraying chamber lid, for example, such as that which is illustrated and described above. Alternatively, this can involve an end effector that controls a single collet pod and preroll held therein. Process step 710 can be automatically performed, such as by an automatically controlled robotic arm and single or multiple collet pod end effector combination.

At subsequent process step 712, pressurized air can be projected into the spraying chamber. This can be done near the top of the spraying chamber, such as by multiple air nozzles that project pressurized air horizontally in a swirling fashion, as noted above. Process step 712 can be automatically performed, such as by an automatically controlled pressurized air delivery system that can include air delivery tubing, vertical openings in the spraying chamber lid, and air nozzles that are located just beneath the lid and oriented in specific directions, for example.

At the next process step 714, adhesive can be sprayed onto one or more prerolls located within the spraying chamber. This can be done by spraying adhesive from an adhesive nozzle directly onto the outer surface of a preroll positioned in front of the nozzle. In some cases, the adhesive can be atomized by the adhesive nozzle from the liquid adhesive material delivered to the nozzle. Process step 714 can be automatically performed, such as by an automatically controlled fluid flow into the adhesive nozzle, which can be configured to accept the fluid flow and turn it into an atomized spray that is ejected outward. In some arrangements, multiple adhesive nozzles can spray multiple prerolls at once, such as five adhesive nozzles spraying five prerolls placed in front of the nozzles.

At a following process step 716, air and excess or oversprayed adhesive material can be vacuumed from the spraying chamber toward a spraying chamber exit through a complex exit air path. Such a complex air path can be that which is describe above with respect to a baffle arrangement that forces hot air and hot oversprayed adhesive material to travel back and forth across many baffles to maximize the surface area exposed to the hot and stick excess adhesive material. Process step 716 can be automatically performed, such as by an automatically controlled vacuum pump and filter arrangement located downstream of exit tubing outside of the spraying chamber exit.

At a subsequent process step 718, the one or more sprayed prerolls can be removed from the spraying chamber. This can involve raising the end effector controlling multiple collet pods holding multiple prerolls such that the prerolls are raised through the openings in the spraying chamber lid, for example, such as that which is illustrated and described above. This can alternatively involve a robotic arm and single collet pod end effector for a single preroll being sprayed at a time. Process step 710 can be automatically performed, such as by an automatically controlled robotic arm and collet pod end effector combination.

At the next process step 720, oversprayed adhesive material can be collected from internal spraying chamber surfaces. This can be done in order to recycle valuable adhesive material, such as where the adhesive material includes a cannabis based oil or distillate. Process step 720 can be automatically performed such as by a specifically arranged collection device or arrangement. This can include a distillate drain, collection, and pumping arrangement, for example. Alternatively, collection can be done manually, which can include removing one or more internal chamber surfaces and placing them into an oven to heat and melt the distillate material and then collect the material in a collection pan, as noted above for a removable baffle arrangement. The method can then end at end step 722.

For the foregoing detailed method 700, it will be appreciated that not all process steps are necessary, and that other process steps and details may be added. For example, additional process steps may include spinning or rotating prerolls while the prerolls are being sprayed within the chamber. As another example, further process steps can involve spraying five prerolls with five nozzles and then rotating the end effector to spray five different prerolls with the same five nozzles such that a total of ten prerolls are sprayed. Furthermore, the order of steps may be altered in some cases, and some steps may be performed simultaneously. For example, step 706 may be performed before step 704. Also, steps 704-708 may be performed simultaneously in some arrangements. As another example, steps 712-716 may be performed simultaneously in some arrangements. Other variations and extrapolations of detailed method 700 will also be readily appreciated by those of skill in the art.

### Fluidized Bed Coating System

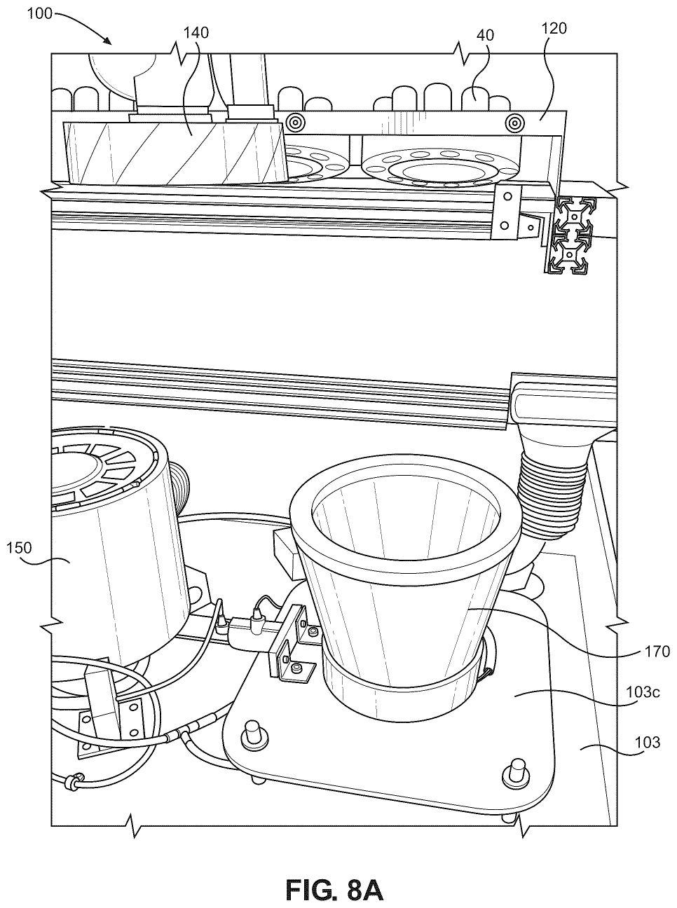

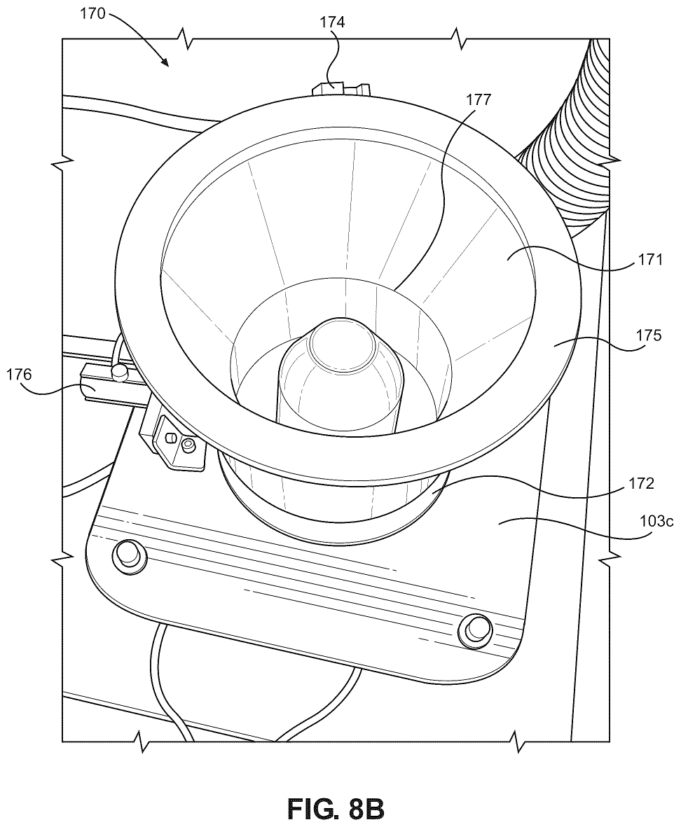

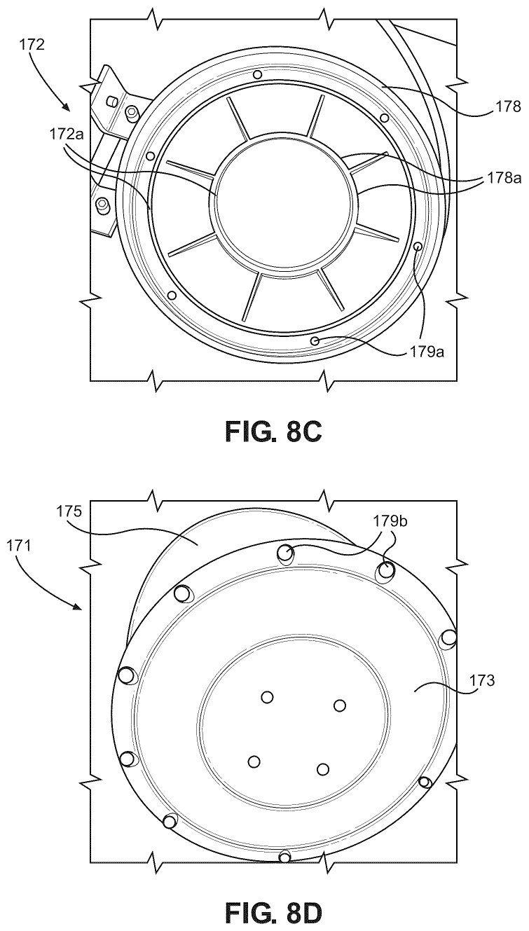

Turning next to FIG. 8A, an example multiple collet fluidized bed coating station within a prerolled cigarette handling system is illustrated in top rear perspective view. As detailed above, infused preroll formation system 100 can include collet pod loading station 120 that can have multiple collet pods 40 located thereon, multiple collet pod end effector 140, adhesive spraying station 150, and fluidized bed coating station 170, among other components and processing stations. Fluidized bed coating station 170, which can also be called a fluidized bed coating system, can be similar in many regards to fluidized bed coating station 70 for single collet pod use above, only larger and scaled for multiple collet pods and prerolls being dipped therein simultaneously. In some arrangements, fluidized bed coating station can be located on a dedicated platform 103c raised above and supported by shelf 103 across the chassis of overall system 100, as shown.

Similar to single collet pod coating station 70 above, fluidized bed coating station 170 can be a kief application station where kief can be applied to coat prerolls that have had adhesive applied to outer surfaces thereof in adhesive spraying station 150. Other types of powders that may be cannabis-derived can also be used to coat prerolls at fluidized bed coating station 170. Again, such a coating station can incorporate advanced pressure and temperature regulation mechanisms to ensure optimal fluidization conditions, resulting in a uniform and high-quality powder coating to complete the process of forming infused prerolls from existing prerolls. In general, a positive pressure and suitable pressure can be applied at the bottom of coating station 170, whereupon a fluidized bed of coating material can be generated and adhesive applied prerolls can be dipped into the fluidized bed for coating.

FIG. 8B illustrates in top perspective view just the fluidized bed coating station of FIG. 8A. Fluidized bed coating station 170 can include many similar components to the single collet coating station 70 above, such as coating chamber 171, plenum base 172, sealing gasket 174, chamber housing 175, among other possible components and features. Again, coating chamber 171 can be a hollow inner volume formed within chamber housing 175, and this coating chamber can be configured to hold a fluidized coating material therein, which can include kief or another cannabis based powder in fluidized form, for example. Unlike the foregoing embodiment, coating chamber 171 can be configured to receive multiple collet pods holding multiple prerolls simultaneously through a large opening at the top of the coating chamber, whereupon all prerolls can be dipped into fluidized coating material forming a bed up to a fill line or region 177 within the coating chamber. As noted above, while fluidized bed coating station 170 can have an annulus type formation as shown, it is also contemplated that such a coating station can alternatively be arranged as a straight rectangular section configured to accept multiple collet pods in a straight line.

Fluidized powder such as kief can be flowed through plenum base 172 by way of flow passages and can enter coating chamber 171 through a filtered region at the bottom of chamber housing 175. Again, kief or any other suitable powder can be maintained in a fluidized state by way of controlled pressure, temperature, and flows, as will be readily appreciated. Air curtain delivery 174 can provide a horizontal air curtain beneath an upper rim at the top of coating chamber 171 in any suitable arrangement or manner. Again, such a horizontal air curtain can limit the amount of powder that escapes from coating chamber 171 during a dipping and coating process and can also serve to dislodge loose powder from and secure adhered powder to an infused preroll as it is being removed from coating chamber 171 after dipping and coating. Other components, features, and functions from coating station 70 above can also be applied in the same or similar manners as scaled for multiple preroll processing.

In addition, vibration mechanism 176 can be coupled to platform 103c that also supports plenum base 172 and thus coating chamber 171. In various embodiments, vibration mechanism 176 can be configured to vibrate the entire fluidized bed coating station 170 during a typical dipping and coating process. Vibrating the coating chamber 171, fluidized bed, and dipped prerolls during coating can result in a more even and thorough powder coating applied to each preroll, as will be readily appreciated.

Moving lastly to FIGS. 8C and 8D, an example plenum base for a fluidized bed coating station is shown in top perspective view in FIG. 8C, while an example fluidized coating chamber removed from its plenum base is shown in bottom perspective view in FIG. 8D. Plenum base can include a plenum housing 178 that includes a plurality of fluid passages 178a that promote fluid flow from a plenum at the center of the plenum base. Coating chamber 171 can include a bottom 173 as part of housing 175. At least a portion of bottom 173 can be formed from a porous material that serves as a filter for the fluidized material flowing upward from fluid passages 178a in plenum base 172. In various embodiments, housing 175 and bottom 173 can be integrally formed and can be a combined 3D printed object, with the bed bottom being a porous 3D printed plate rather than a sintered metal filter material as in the case of coating station 70.

In various embodiments, coating chamber 171 can be readily removable from plenum base 172. To accomplish this a plurality of plenum magnets 179a can be distributed about an outer circumference of plenum base 172 and a plurality of corresponding chamber magnets 179b can be distributed about an outer circumference of bottom 173 to coating chamber 171. These pluralities of magnets 179a, 179b can be arranged to correspond to each other such that coating chamber 171 is coupled to and held in place atop plenum base 172 by magnetic forces when the chamber is properly placed atop the plenum base. While these magnetic forces are sufficient to hold the coating chamber firmly in place, a user can remove the coating chamber from the base by applying enough manual force to overcome the collective magnetic forces. In addition, the collective magnetic forces between all pluralities of magnets 179a, 179b can be sufficiently large such that the coating chamber is pulled down hard enough to squeeze inner and outer O-rings 172a located on plenum base 172 to form seals around the porous region of bottom 173.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A system configured to process prerolled cigarettes, the system comprising:
one or more prerolled cigarette holders, wherein each of the one or more prerolled cigarette holders is configured to hold a prerolled cigarette therein;
an adhesive spraying station configured to apply adhesive to one or more prerolled cigarettes held by the one or more prerolled cigarette holders and inserted into the adhesive spraying station; and
a fluidized bed coating station configured to apply a coating to the one or more prerolled cigarettes held by the one or more prerolled cigarette holders after the one or more prerolled cigarettes have had adhesive applied thereto.

2. The system of claim 1, wherein the system is configured to form cannabis based infused prerolled cigarettes.

3. The system of claim 1, wherein operations of the one or more prerolled cigarette holders, the adhesive spraying station, the fluidized bed coating station, or any combination thereof are performed automatically by one or more system processors.

4. The system of claim 1, wherein each of the one or more prerolled cigarette holders includes a collet device configured to hold a prerolled cigarette therein.

5. The system of claim 4, wherein each collet device includes an enclosure defining an elongated shape and an enclosure opening at a distal end thereof, a collet situated within the enclosure and configured to accept the prerolled cigarette inserted through the enclosure opening and into the collet, the collet including a collet opening and a plurality of clamping components configured to actuate between an open position to release the prerolled cigarette and a closed position to hold the prerolled cigarette, and an internal magnetic component located within the enclosure, the internal magnetic component being configured to facilitate actuation of the collet between the open position and the closed position based on magnetic interactions between the internal magnetic component and a separate external activating magnetic component located outside the collet device and proximate the internal magnetic component.

6. The system of claim 1, wherein the adhesive spraying station includes an adhesive tank, a spraying chamber, one or more spraying nozzles, and a spraying chamber heating component configured to heat the spraying chamber during a spraying operation.

7. The system of claim 1, wherein the fluidized bed coating station includes a coating chamber that is removably coupled to a plenum base by way of multiple magnetic pairings.

8. The system of claim 1, further comprising:
a prerolled cigarette holder loading station having one or more prerolled cigarette holder start and end locations.

9. The system of claim 8, wherein the prerolled cigarette loading station includes a top plate having a plurality of prerolled cigarette holder top openings therethrough and one or more floor components with corresponding prerolled cigarette holder floor openings that are configured to move relative to the top plate.

10. The system of claim 1, further comprising:
a robotic arm configured to transport automatically within the system one or more prerolled cigarette holders while one or more prerolled cigarettes are held therein; and
an end effector coupled to the robotic arm and configured to couple to and control the one or more prerolled cigarette holders, wherein the end effector is configured to facilitate the simultaneous processing of one or more prerolled cigarettes held by the one or more prerolled cigarette holders at the adhesive spraying station and the fluidized bed coating station.

11. An end effector, comprising:
a robotic arm coupling component configured to couple the end effector to a movable end of a robotic arm;
one or more collet device coupling components, each of which are configured to removably couple the end effector to a separate collet device, wherein each separate collet device is configured to hold a separate object therein; and
one or more activating magnetic components, wherein each of the one or more activating magnetic components is configured to interact with an internal magnetic component located within one of the separate collet devices to facilitate actuation of the separate collet device between an open position and a closed position.

12. The end effector of claim 11, wherein at least a portion of the one or more activating magnetic components are electromagnets configured to deliver a variable magnetic field.

13. The end effector of claim 11, wherein each separate collet device is a prerolled cigarette holder and each separate object is a prerolled cigarette.

14. The end effector of claim 13, wherein the end effector is configured to facilitate the simultaneous processing of multiple prerolled cigarettes held by multiple prerolled cigarette holders at an adhesive spraying station and a fluidized bed coating station within a system configured to process prerolled cigarettes.

15. The end effector of claim 11, wherein the end effector includes multiple collet device coupling components, the end effector further comprising:
an end effector plate having an opening therethrough for each separate collet device coupling component;
a drive head and mounting pin for each separate collet device coupling component, wherein the drive head and mounting pin are configured to spin in place along a longitudinal axis thereof to facilitate spinning of a separate collet device coupled to the collet device coupling component; and
a drive component configured to rotate the entire end effector about a central axis thereof such that all collet device coupling components rotate about the central axis.

16. A system configured for the loading and unloading of collet devices, the system comprising:
a top plate having a plurality of collet device top openings therethrough; and
one or more floor components coupled to and located directly adjacent to the top plate, each of the one or more floor components having one or more collet device floor openings and being configured to move relative to the top plate, wherein an opening movement of each of the one or more floor components results in collet device floor openings aligning with collet device top openings to allow a separate collet device to pass through simultaneously the top plate and bottom plate and a closing movement of each of the one or more floor components results in collet device floor openings misaligning with collet device top openings to block the separate collet device from passing through simultaneously the top plate and bottom plate.

17. The system of claim 16, wherein the system comprises a collet pod loading station located within an overall system configured to process prerolled cigarettes, and wherein the collet pod loading station is located within a recessed window of the overall system configured to process prerolled cigarettes that is accessible to a manual operator without accessing any internal region of the overall system configured to process prerolled cigarettes.

18. The system of claim 16, wherein the plurality of collet device top openings are arranged into multiple loading regions, each loading region forming multiple collet device top openings that are configured to be used for all collet devices being simultaneously coupled to or uncoupled from a separate multiple collet device end effector.

19. The system of claim 16, wherein movement of a floor component is a rotational movement such that each of its collet device floor openings rotates about a floor component center.

20. The system of claim 16, wherein the top plate includes a plurality of top plate magnetic components and each floor component includes a plurality of floor component magnetic components, and wherein the floor component magnetic components interact with the top plate magnetic components during movement of a respective floor component.
